(19) United States
(12) Patent Application Publication
(10) Pub. No.: US 2008/0293451 A1
(43) Pub. Date: Nov. 27, 2008

(54) Sectorisation of Cellular Radio

(75) Inventors: Philip Edward Haskell, Hampshire (GB); Ian Jeffrey Letzer, Worcestershire (GB); Louis David Thomas, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QUINTEL TECHNOLOGY LIMITED, Farnborough (GB)

(21) Appl. No.: 11/791,686

(22) PCT Filed: Nov. 24, 2005
(86) PCT No.: PCT/GB05/04531

§ 371 Date: May 25, 2007

(30) Foreign Application Priority Data
Dec. 1, 2004 (GB) 0426354.7

(51) Int. Cl. H04M 1/00

(52) U.S. Cl. 455/562.1

(57) ABSTRACT

An antenna installation for cellular radio has four antennas ANT 1A, ANT 1B, ANT 2 and ANT 3 mounted on respective sides of a rectangular support 48 and giving rise to four antenna coverage sectors 1A and 1B and sectors 2 and 3. A splitter/combiner unit (SCU) receives three signals (1, 2 and 3) from a base station, and splits signal 1 into two signals 1A and 1B of equal power. The splitter/combiner 5C1 acts as a splitter in transmit mode and a combiner in receive mode. The signals 1A, 1B, 2 and 3 are connected to antennas ANT 1A, ANT 1B ANT 2 and ANT 3 respectively. Split signal antennas ANT 1A, ANT 1B carrying the same transmit signal are not adjacent to one another: they are separated from one another by another sector associated with a different signal, and therefore do not overlap sufficiently to affect communications significantly. This avoids creation of signal interference regions in antenna coverage areas which would lead to signals being partially unobtainable there.

This invention relates to sectorisation of cellular radio, that is to say an apparatus and a method of operation for a cellular radio antenna installation employing transmission/reception sectors.

Use of cellular mobile radio (familiarly known as mobile telephones) continues to expand, and there is a requirement for increased data rate (traffic throughput) to users which in turn requires additional antenna capacity. However, against this, authorities responsible for planning or zoning are increasingly resistant to establishment of new antenna sites and even to addition of further antennas to existing antenna sites. In consequence, operators of cellular mobile radio networks are using coverage improvement as a means of increasing traffic throughput, and are implementing it, wherever possible, with antenna installations having low visual impact on the environment. Traffic throughput can be increased by (a) increasing bandwidth, i.e. adding more channels; (b) increasing transmitted power; (c) reducing antenna beam width; or (d) reducing noise power. Of these, bandwidth and transmitted effective radiated power (ERP) are limited by operator license terms. Operator choice is between reducing horizontal or vertical antenna beam width, or antenna noise power. Here noise power arises from self-interference between signals passing to or from adjacent overlapping regions (cells) served by an antenna system. Reduction in antenna beam width also makes it possible to direct increased transmitted radio frequency (RF) energy to a particular geographical area, and to minimise noise power from adjacent cells.

A typical prior art cellular radio antenna installation has three sectors, each with a horizontal beam width of 120 degrees measured at points where gain is 10 dB down relative to antenna boresight gain. Such a three sector arrangement is advantageous in minimising the number of frequencies required for frequency re-use in a Frequency Division Multiplex (FDM) system. Also, it has a hexagonal tessellate which increases traffic capacity for a uniform spatial distribution of subscribers. An operator has three variables to optimise coverage of such an antenna installation as follows: (a) mechanical or (b) electrical down tilt of the antenna radome, and (c) power fed to each sector.

If an antenna installation requires increased throughput, then the three sectors can be increased to six by adding a further base station: the antennas then each have a 60 degree horizontal beam width. They are usually mounted on a single triangular cross-section gantry, and they are pointed to cover a 360 arc with a respective pair of antennas on each side of the gantry.

U.S. Pat. No. 4,211,894 to Watanabe et al. discloses splitting and recombining base station signals so that all signals are fed to all sectors. In practice there is always a degree of spatial overlap between adjacent sectors, so feeding all signals to all sectors results in interference patterns and consequent unreliable communication in overlap regions.

U.S. Pat. No 6,611,511 to Schulz discloses splitting base station signals, delaying one of the split signals, and then re-combining the signals and feeding them to a single sector. This results in an increase in communications efficiency but not in coverage.

U.S. Pat. No. 5,714,957 also discloses splitting a transmit signal into a number of over-lapping beams in a non-sectored arrangement. This allows antenna coverage to provide a better match to actual cell topology, but signal interference occurs in beam overlap regions and traffic throughput is not improved.

Splitting of transmitter signals is also described in ‘Radio Network Planning And Optimisation For UMTS’ by Laiho, Wacker and Novosad, ISBN 0-471-48653-1. This approach facilitates rapid roll-out, but it generates signal interference in the coverage area and decreases traffic throughput.

Conventional antenna installations are often not well matched to territory to be served. In this connection, roads are usually laid out so as to be straight, or nearly so, and on a rectangular grid in urban areas. Similarly railways and rivers are usually straight, or nearly so, on a scale of a propagation distance of a cellular site, e.g. 5 km to 15 km. Also user density and need for reliable communications is generally higher on a transport highway than its surrounding area. A three or six sector antenna installation based on sector beam widths of 120 degrees or 60 degrees: (a) cannot be optimised to cover a line, or rectangular grid, of users, and (b) does not allow mounting of antennas on the sides of a rectangular building without angled supports. Moreover, decreasing the power level to a sector to minimise inter-cell interference reduces the installation's information handling capacity without allowing the resulting excess power to be re-allocated to another sector. Such an installation has too few variable optimisation parameters to optimise coverage, particularly with a non-uniform subscriber spatial distribution, or when the structure of the antenna support arrangement does not match the cell sectorisation requirement.

It is an object of the invention to provide an alternative form of antenna installation for cellular radio

The present invention provides an antenna installation for cellular radio including means for splitting a base station signal into a plurality of split signals, and means for feeding the split signals to respective antennas, the antennas having beams which are sufficiently isolated from one another to provide for mutual interference to have negligible effect on communications performance.

The invention provides a number of advantages. It is configurable to improve matching of antenna coverage to geographical area and power level to subscriber density. It can be adapted for control of antenna pan and tilt, for antenna sharing by multiple operators, and for transmit and receive diversity. Improvements are obtainable by instrumentation added externally to and without modification of a base station.

The antennas may be incorporated in an antenna assembly with other antennas of different gain. They may not all have the same beam width. At least one of the other antennas may have a beam which overlaps one or more other antenna beams.

The antenna installation may include means for adjusting at least one of transmitted power and receiver sensitivity of an antenna relative to another antenna and means for adjusting at least one of antenna electrical pan and tilt. It may include power amplifiers arranged to amplify split signals and filtering means for separating receive signals and for routing them to different base station ports.

The antennas may be arranged for transmit polarisation diversity. The installation may include combining means such as filtering means or hybrid coupling means for combining a plurality of base station transmit signals for antenna sharing purposes. The antennas may be shared between four operators and the installation be arranged for receive polarisation diversity.

The antennas may be shared between a plurality of operators using contiguous signal frequencies, the installation having means for separating the signals into groups with non-contiguous frequencies, means for combining grouped signals and means for combining the groups to enable antenna sharing.

The installation may be arranged for transmit diversity and for power distribution to be adjustable between operators. Antenna electrical pan and tilt and power distribution may be adjustable.

In another aspect, the present invention provides a method of operation of a cellular radio antenna installation including splitting a base station signal into a plurality of split signals, and feeding the split signals to respective antennas, the antennas having beams which are sufficiently isolated from one another to provide for mutual interference to have negligible effect on communications performance.

The antennas may be incorporated in an antenna assembly with other antennas of different gain. Antennas in the antenna assembly may not all have the same beam width. At least one of the other antennas may have a beam which overlaps one or more other antenna beams.

The antenna installation may include means for adjusting at least one of transmitted power and receiver sensitivity of an antenna relative to another antenna and means for adjusting at least one of antenna electrical pan and tilt. It may include power amplifiers arranged to amplify split signals and filtering means for separating receive signals and for routing them to different base station ports.

The antennas may be arranged for transmit polarisation diversity. The installation may include combining means such as filtering means or hybrid coupling means for combining a plurality of base station transmit signals for antenna sharing purposes. The antennas may be shared between four operators and the installation be arranged for receive polarisation diversity.

The antennas may be shared between a plurality of operators using contiguous signal frequencies, the method including separating the signals into groups with non-contiguous frequencies, combining grouped signals and combining the groups to enable antenna sharing.

The method may provide for transmit diversity and may include adjusting power distribution between operators. It may include adjusting antenna electrical pan and tilt and power distribution.

In order that the invention might be more fully understood, embodiments thereof will now be described, by way of example only, with reference to the accompanying drawings, in which:—

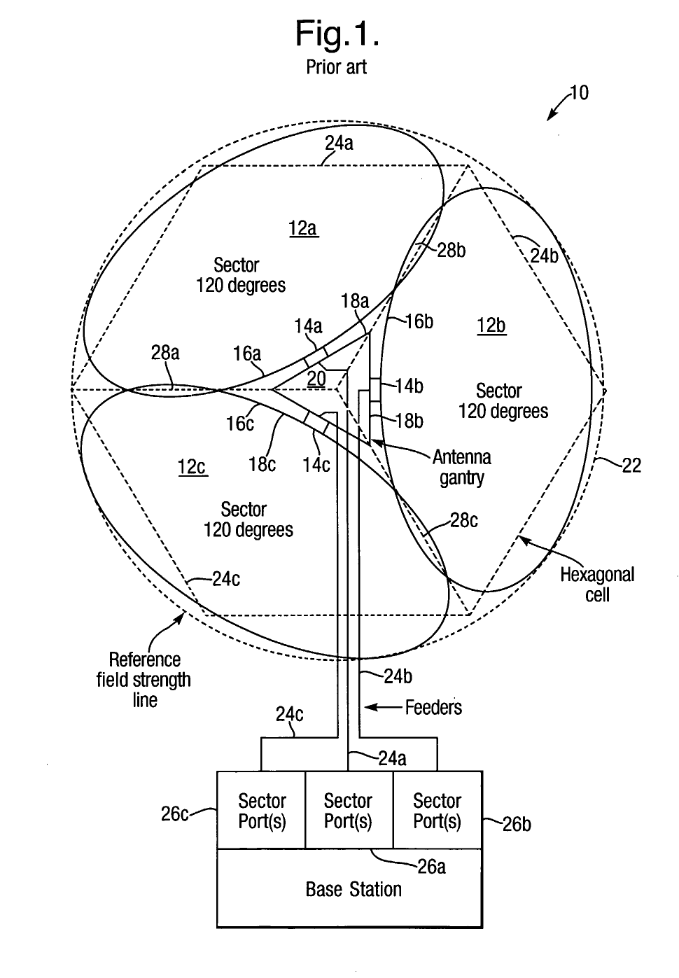

FIG. 1 shows a prior art three sector antenna installation;

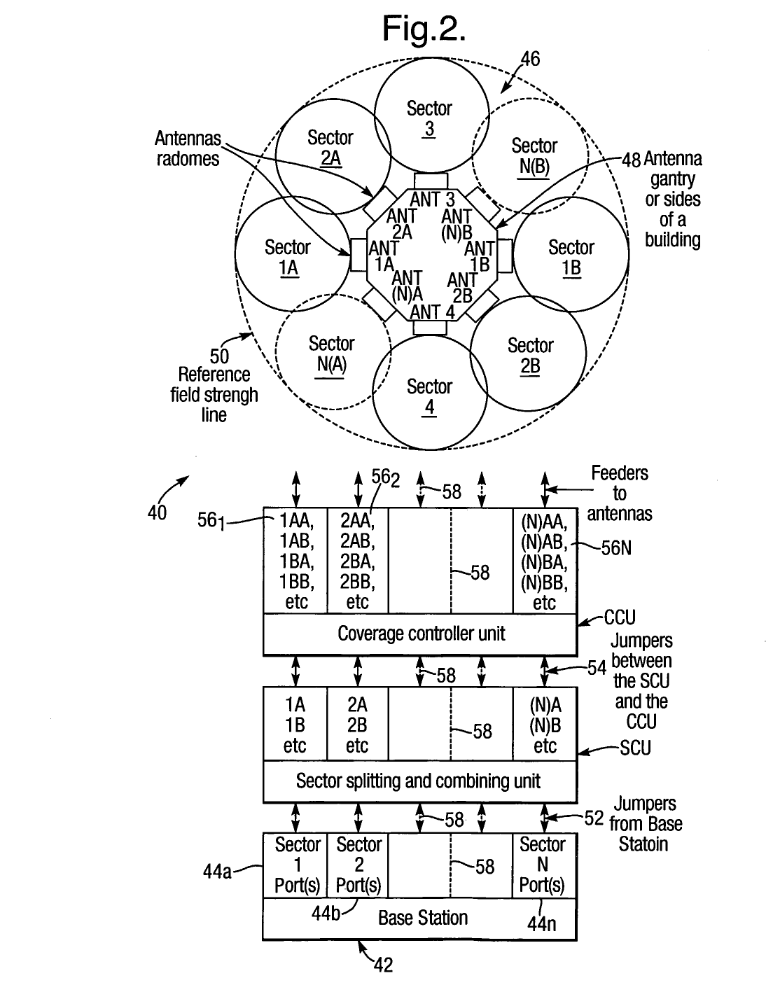

FIG. 2 illustrates one embodiment of a multi-sector antenna installation of the invention;

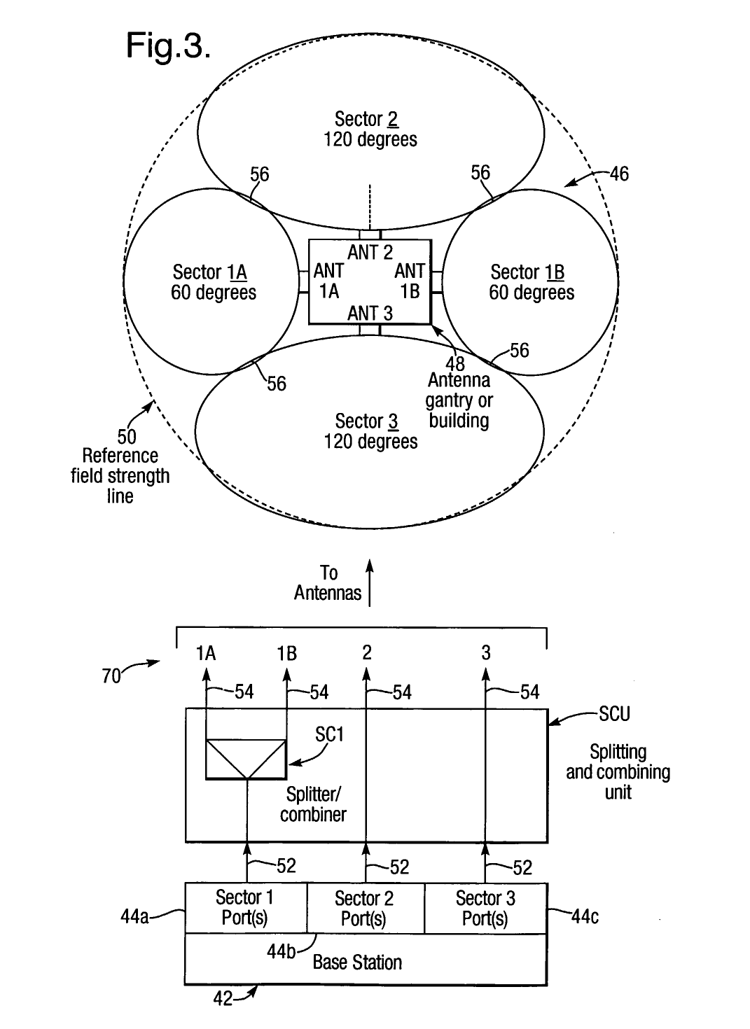

FIG. 3 shows a four sector antenna installation of the invention;

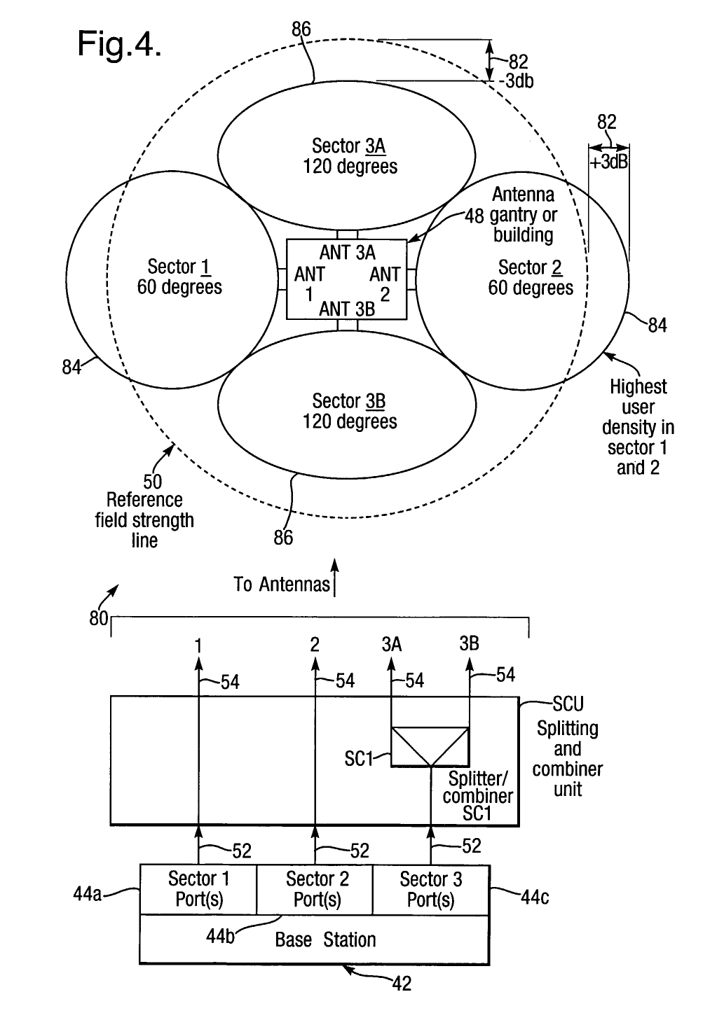

FIG. 4 illustrates a four sector antenna installation of the invention suitable for a non-uniform distribution of users;

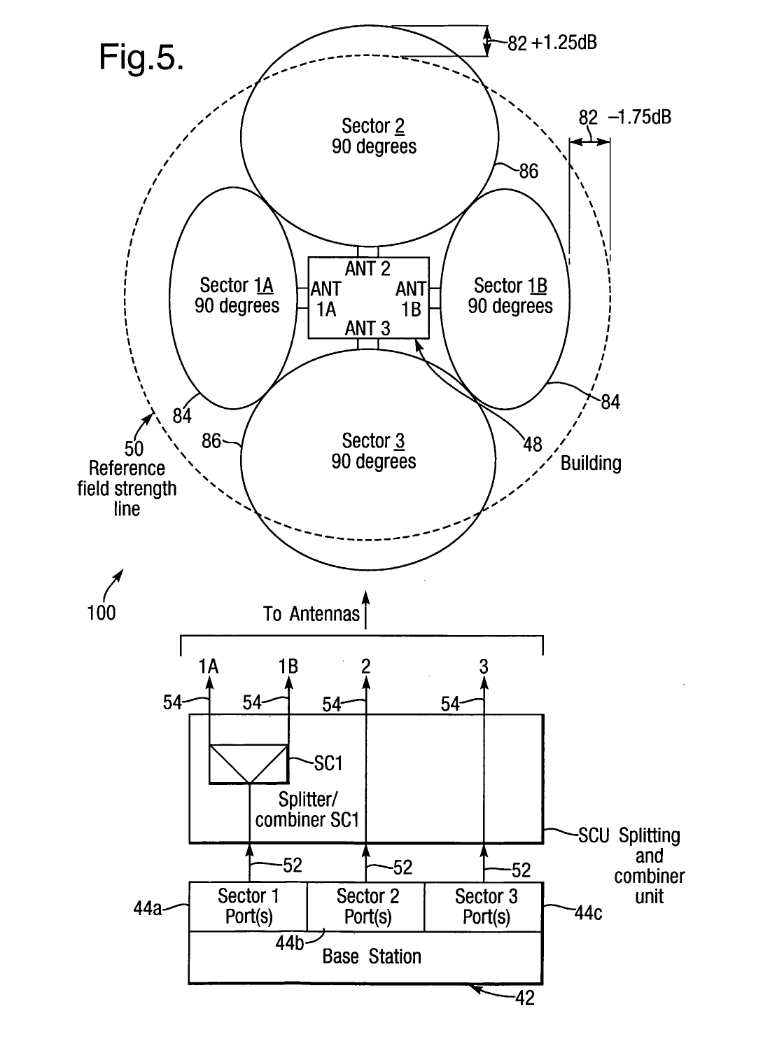

FIG. 5 is equivalent to FIG. 4 except that it has equal beam width antennas;

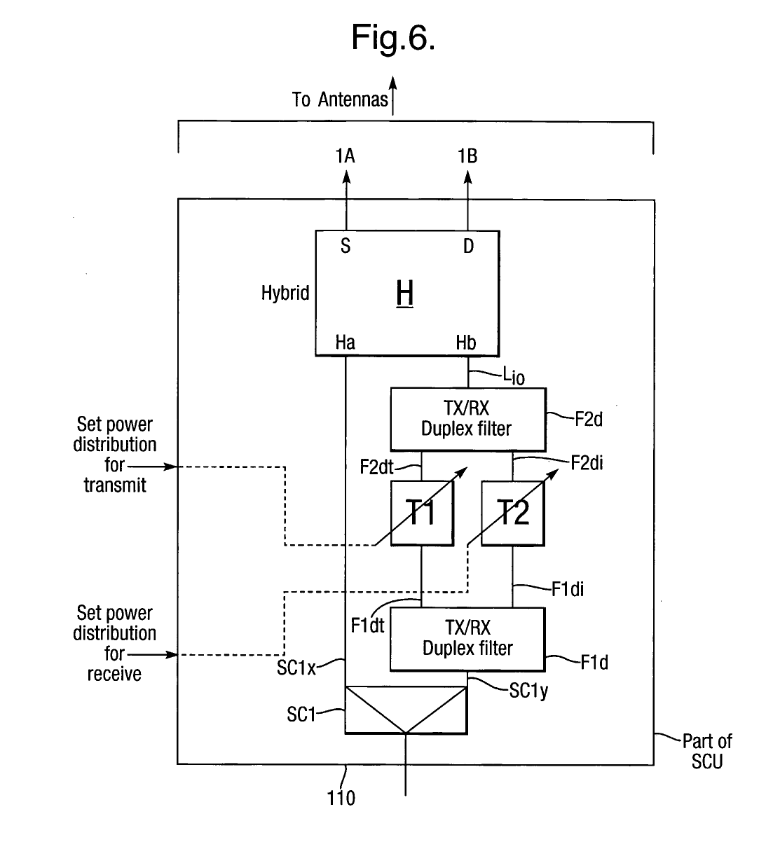

FIG. 6 shows a power distribution module for use in a multi-sector antenna installation of the invention;

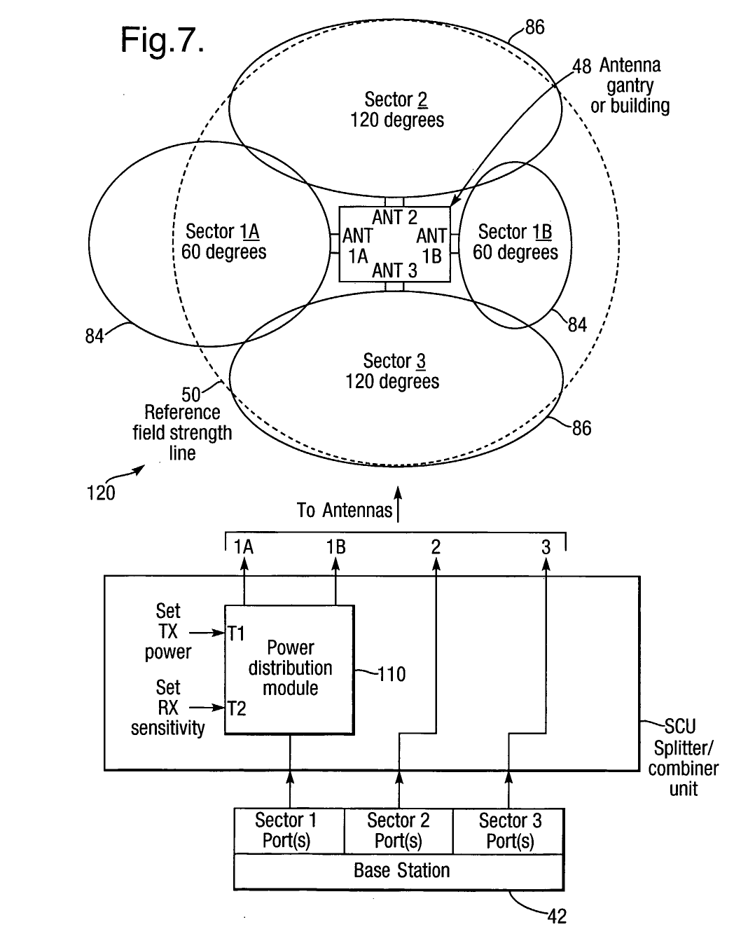

FIG. 7 is an antenna installation of the invention with power distribution and receiver sensitivity control;

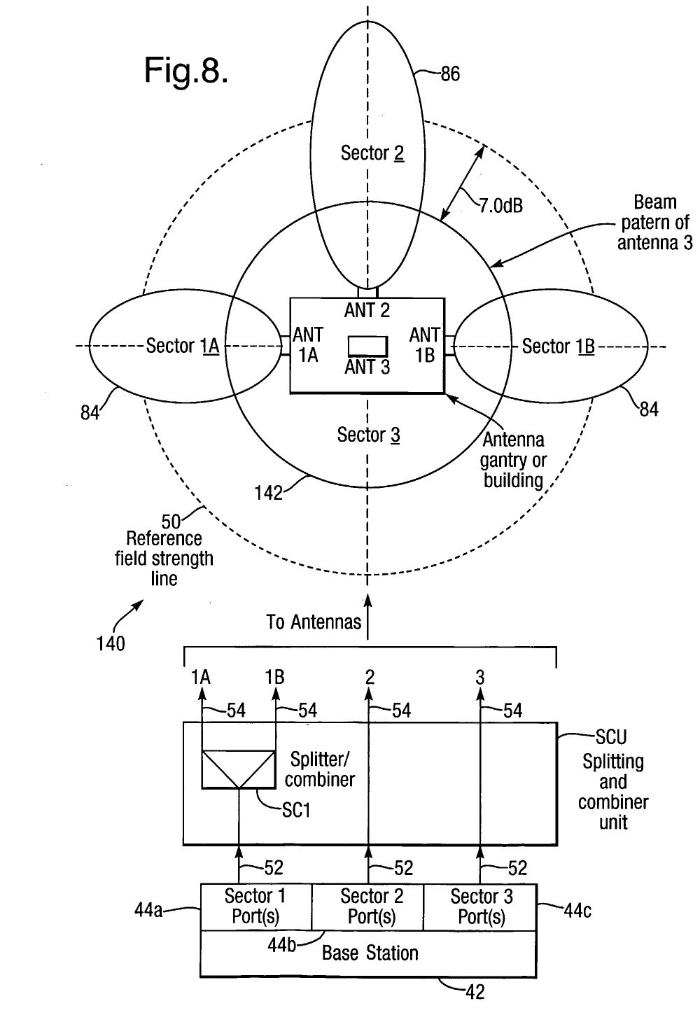

FIGS. 8 to 10 show antenna installations of the invention with sectors superimposed or overlaid on one another but with differing overlay patterns;

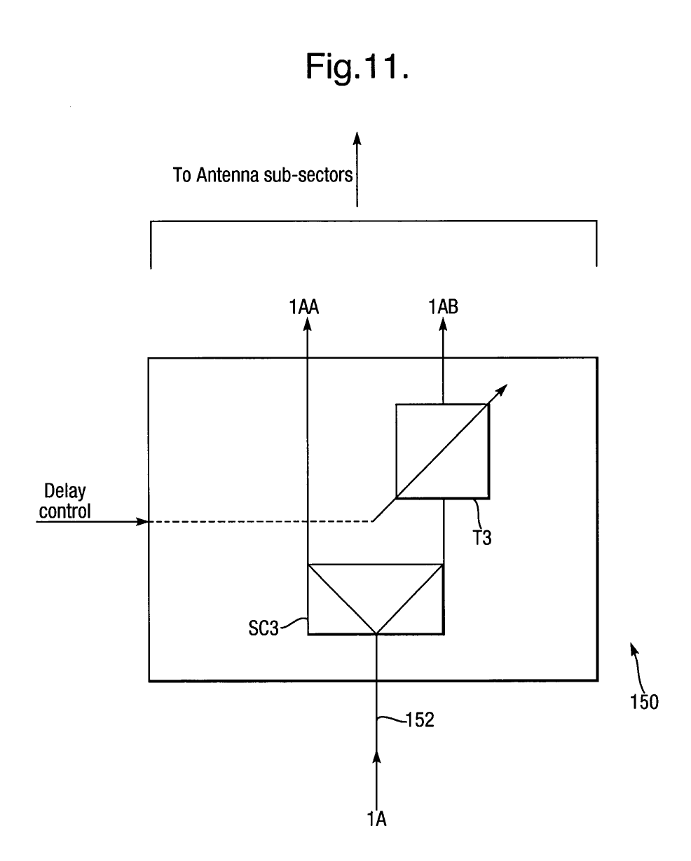

FIG. 11 shows a split and delay module for implementation of either antenna pan or tilt, or both antenna pan and tilt;

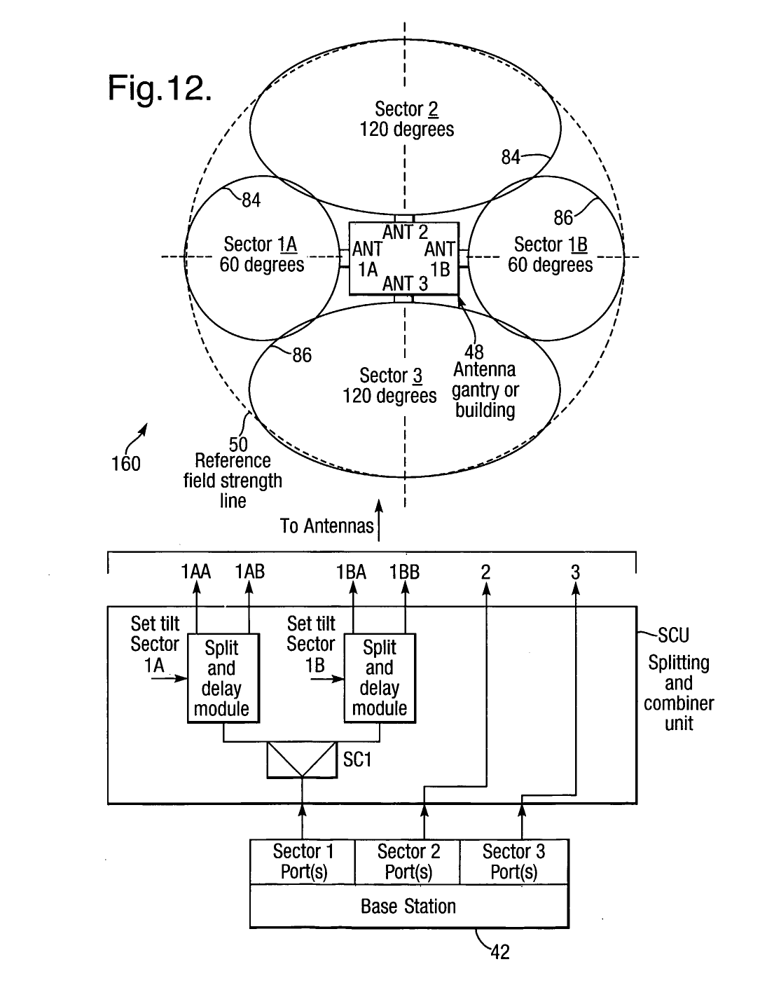

FIG. 12 is an antenna installation of the invention using the FIG. 11 module to implement electrical tilt;

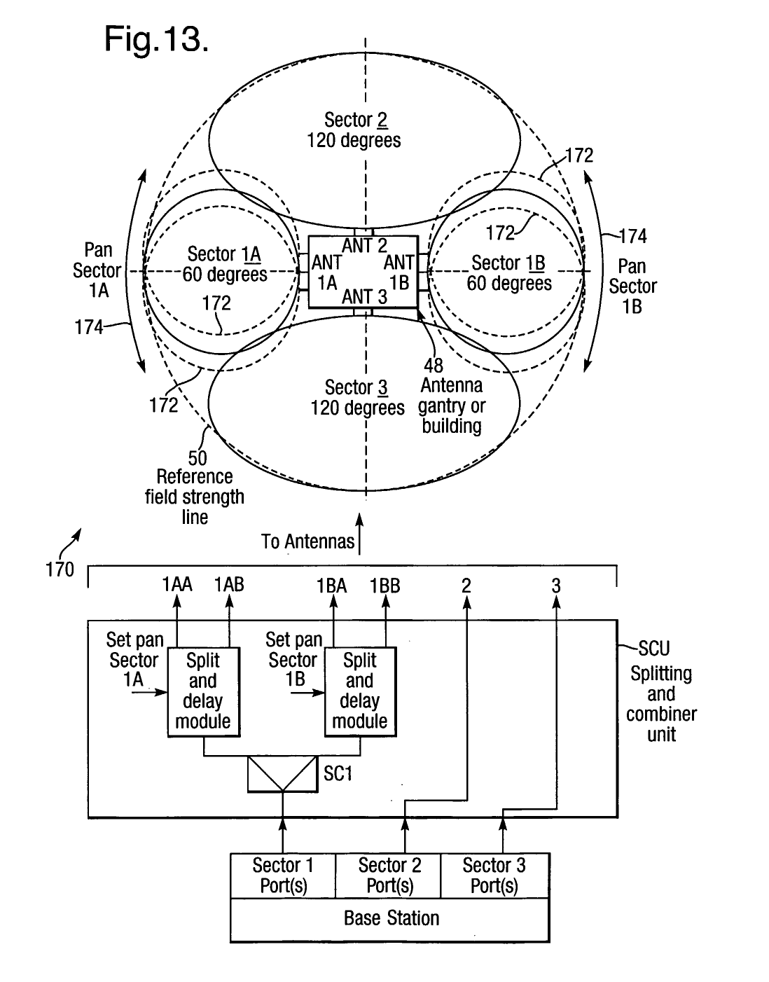

FIG. 13 shows an antenna installation of the invention with split signal sectors having independently and remotely adjustable angle of electrical pan;

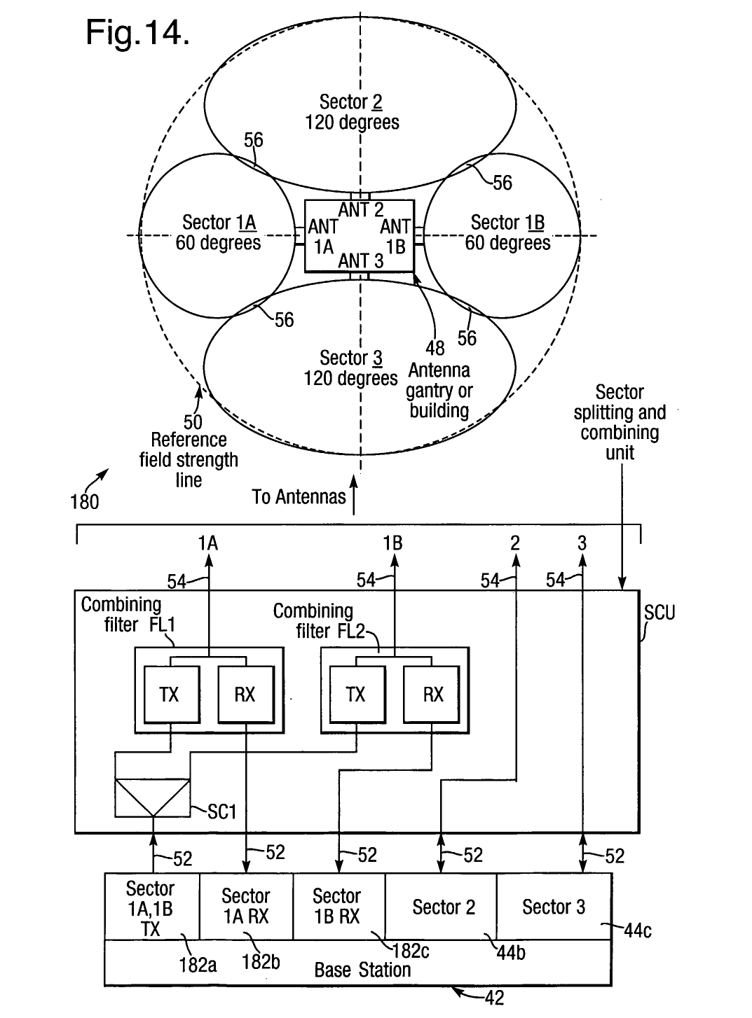

FIG. 14 shows an antenna installation of the invention with improved up-link performance;

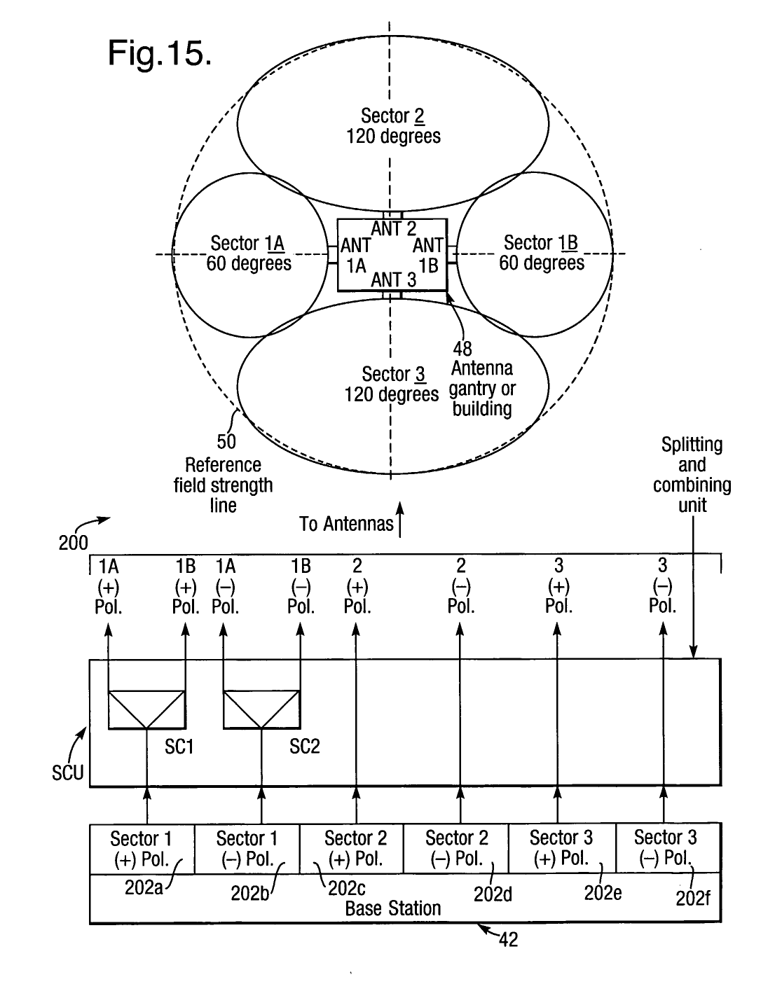

FIG. 15 shows an antenna installation of the invention with transmit diversity;

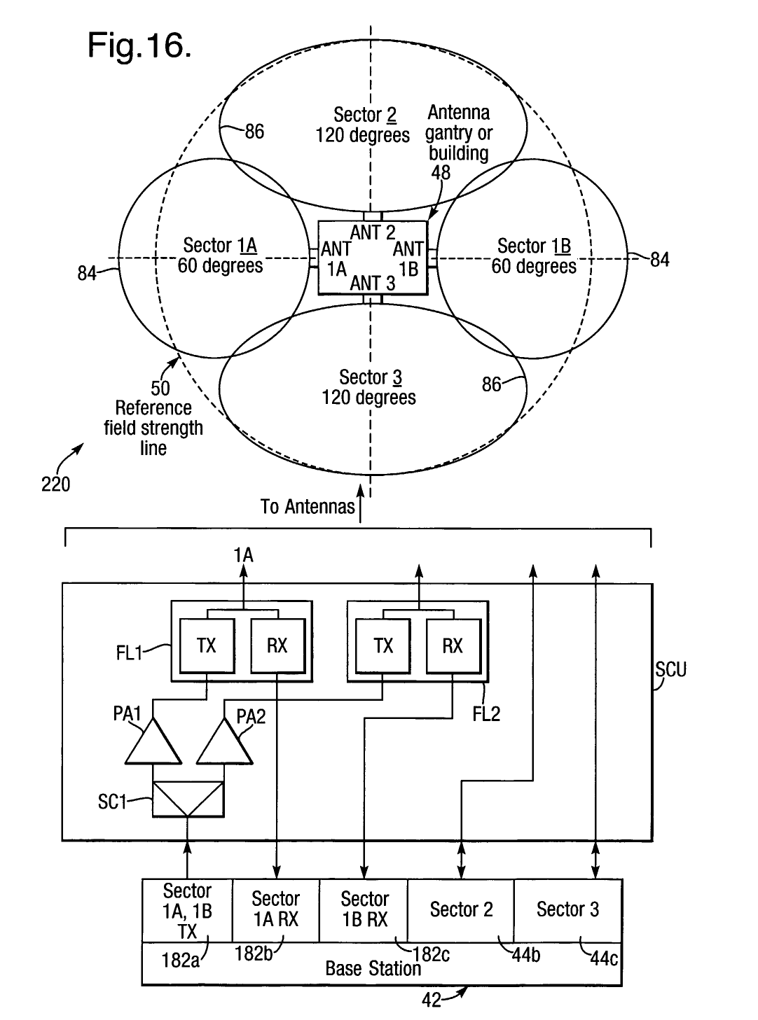

FIG. 16 shows an antenna installation of the invention with increased power to split signal sectors;

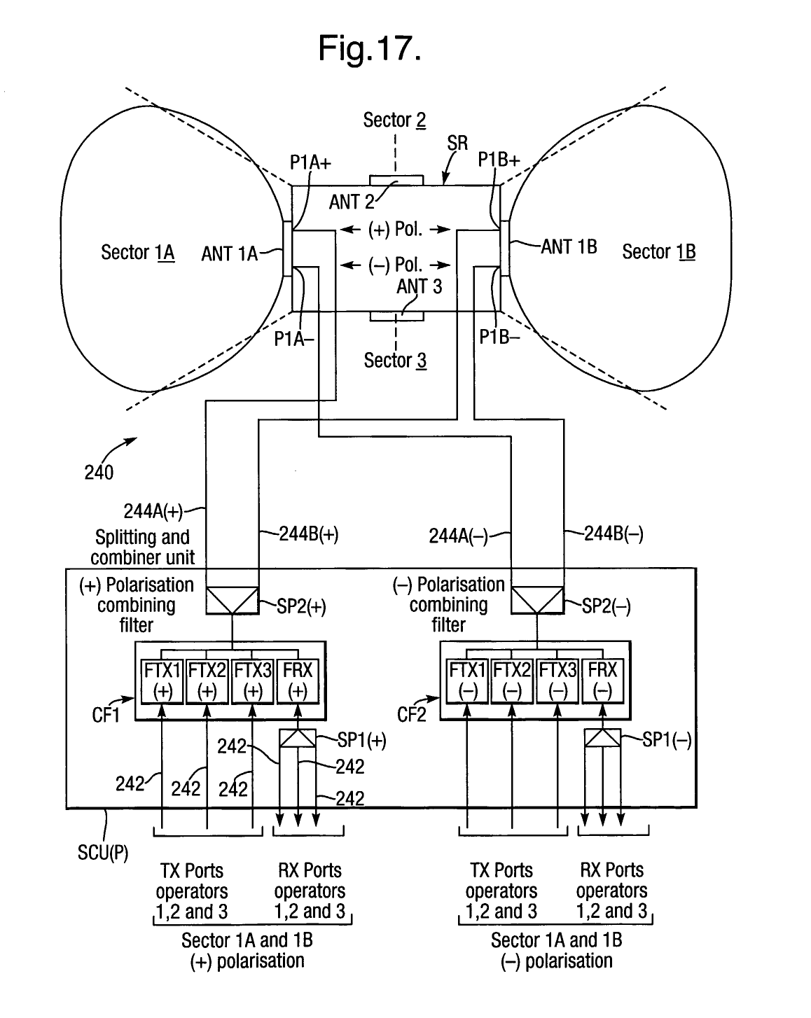

FIG. 17 shows an antenna installation of the invention with low loss signal combining, sharing operators with non-contiguous frequencies and transmit diversity;

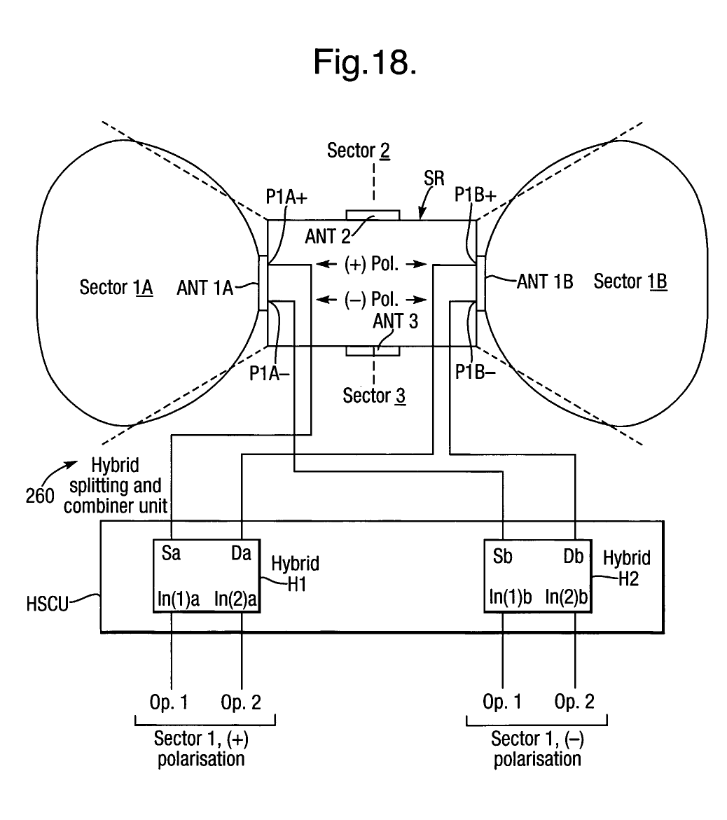

FIG. 18 shows an antenna installation of the invention with low loss signal combining of contiguous frequencies, two sharing operators and transmit diversity;

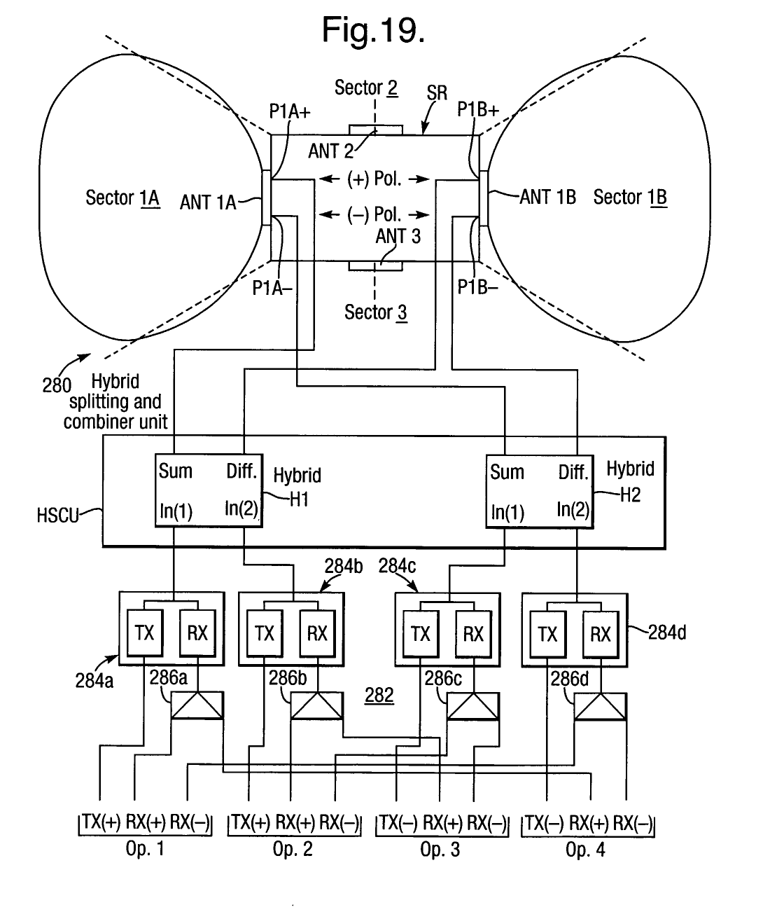

FIG. 19 shows an antenna installation of the invention with low loss combining of contiguous frequencies and four sharing operators but without transmit diversity;

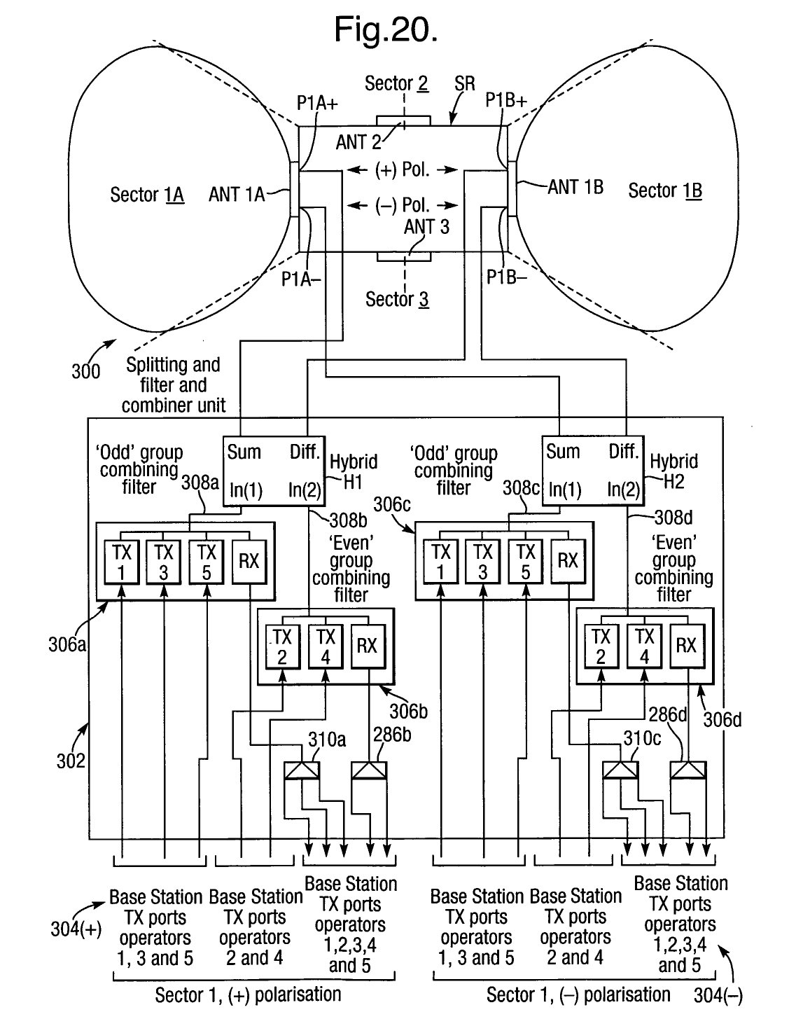

FIG. 20 shows an antenna installation of the invention with low loss combining of contiguous frequencies, multiple sharing operators and transmit diversity;

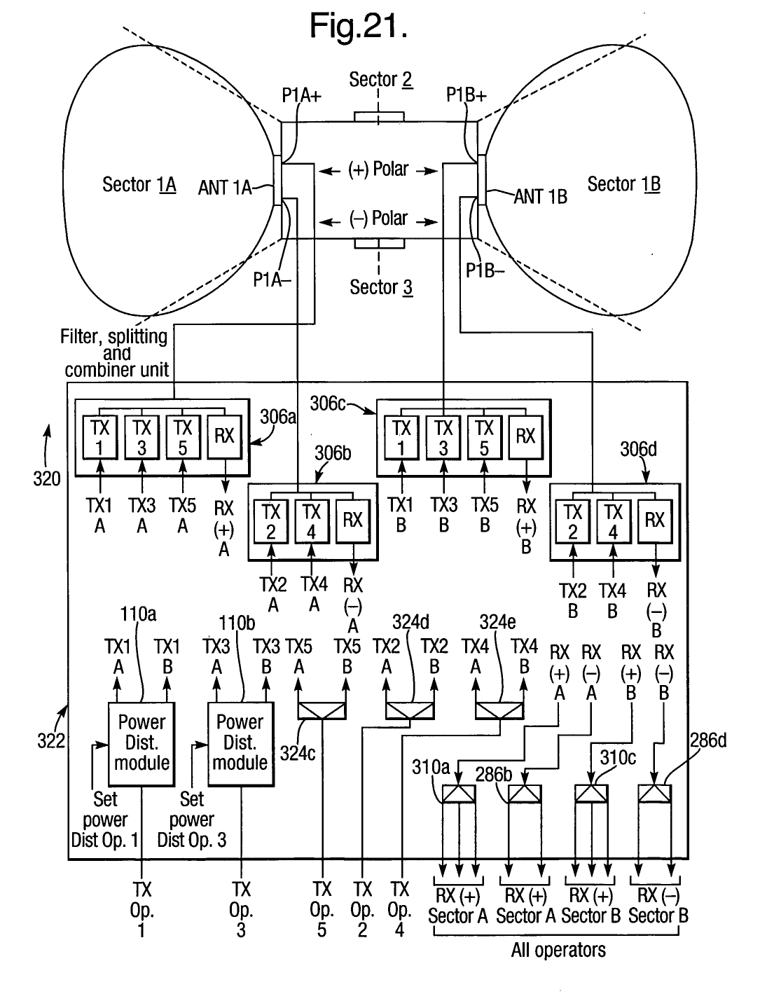

FIG. 21 shows an antenna installation of the invention with low loss combining of contiguous frequencies, five sharing operators and power distribution for first and third operators;

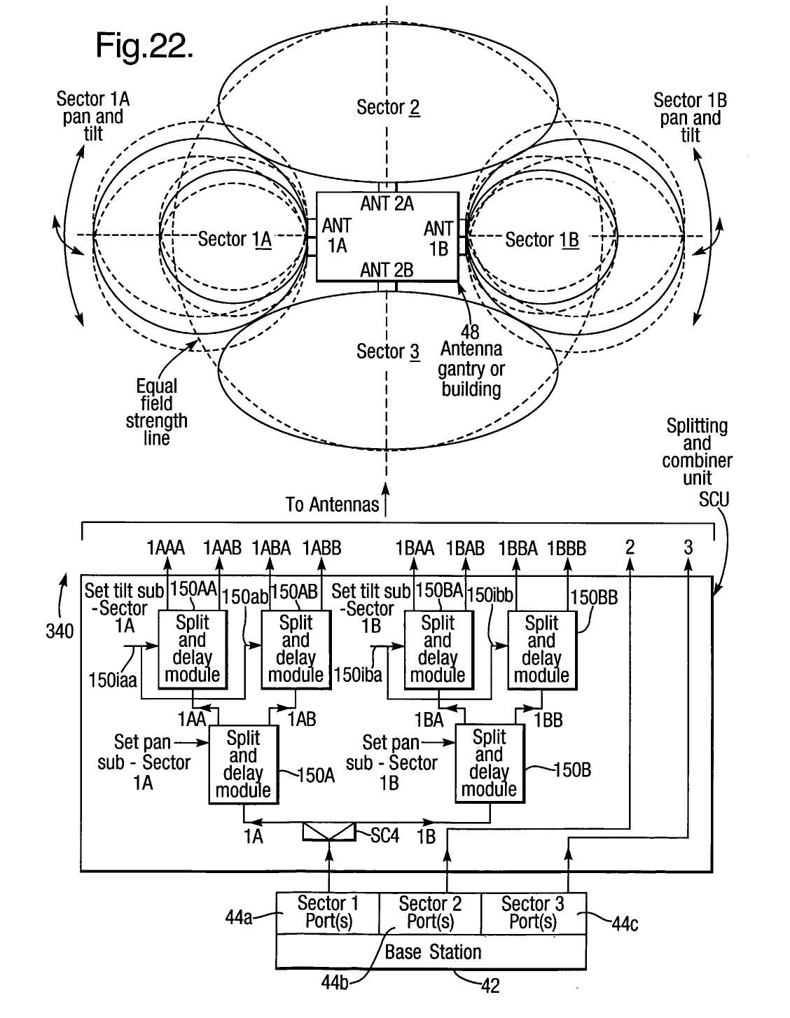

FIG. 22 shows an antenna installation of the invention implementing signal splitting with pan and tilt;

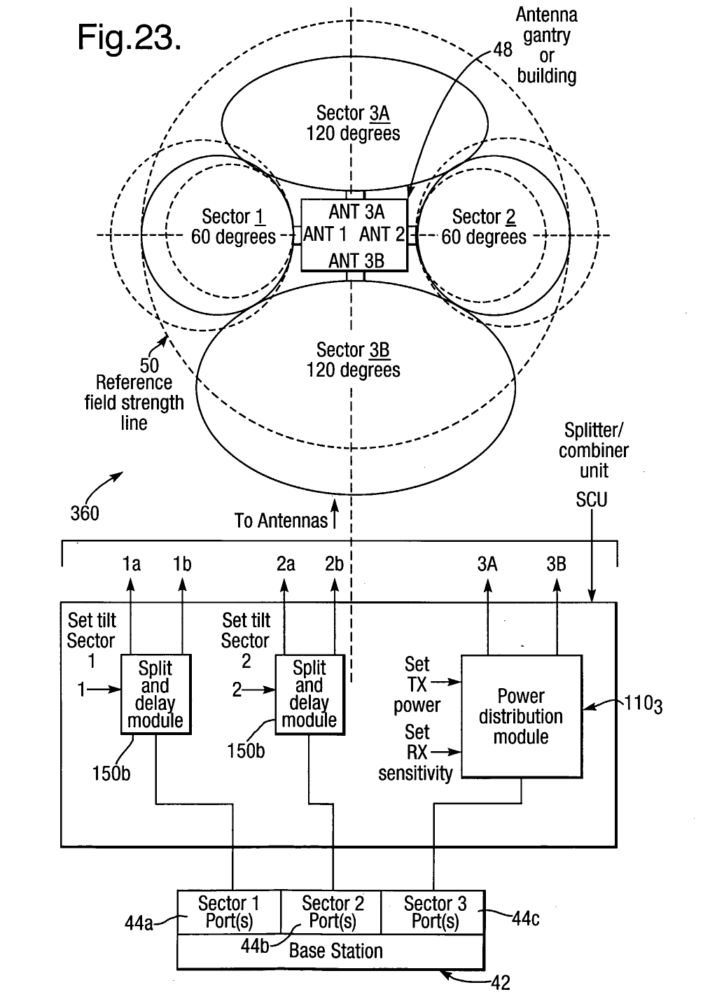

FIG. 23 shows an antenna installation of the invention implementing signal splitting with tilt and power distribution; and

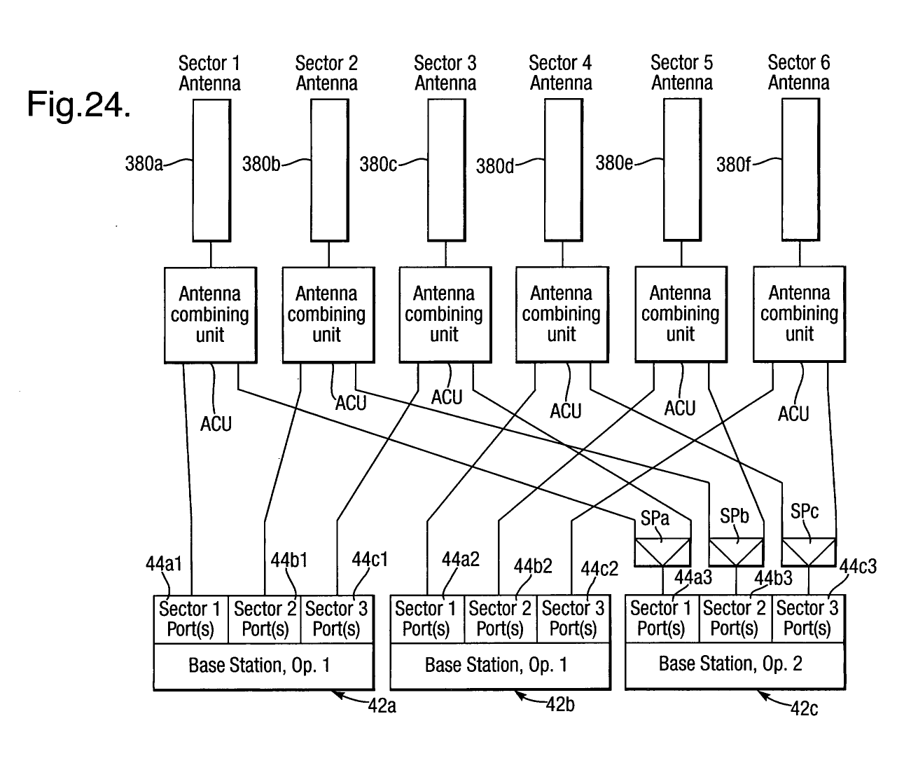

FIG. 24 shows an antenna installation of the invention implementing signal splitting, six sector antenna sharing and differing operator sectorisation requirements.

Referring to FIG. 1, a conventional prior art antenna installation 10 has three sectors 12a, 12b and 12c with respective antennas 14a, 14b and 14c. Each of the antennas 14a, 14b and 14c has a horizontal beam width of 120 degrees measured to points (10 dB down points) on respective horizontal radiation patterns 16a, 16b and 16c where antenna gain is 10 dB down relative to antenna boresight gain. The radomes 14a, 14b and 14c are mounted upon respective vertical faces 18a, 18b and 18c of a gantry 20 of triangular cross-section. The radiation patterns 16a, 16b and 16c are respective antenna coverage patterns. For comparison with coverage provided by embodiments of the invention to be described later, a reference field strength line 22 (chain line) is shown. Via feeders 24a, 24b and 24c, the radomes 14a, 14b and 14c communicate with respective base station sectors 26a, 26b and 26c having one or more ports per sector.

Installations such as 10 having three sectors are advantageous in minimising the number of frequencies required for frequency re-use in a Frequency Division Multiplex (FDM) System. Also, the installation 10 has hexagonal cells, which maximises communications capacity for a spatial distribution of subscribers which is uniform.

An operator of the installation 10 has three variables to optimise antenna coverage, i.e. subscriber area with which the operator's antenna will communicate: mechanical or electrical down tilt of the operator's antenna radome, or power fed to each sector 12a, 12b and 12c. If an antenna installation requires increased throughput then the number of sectors may be increased to six by adding a further base station and using six antennas each with a 60 degree horizontal beam width. Six antennas may be mounted in pairs on vertical faces of a triangular cross-section gantry, and pointed so that a 360 arc is covered by pairs of antennas with 60 degree divergent beams.

If base station signals are split and combined as in the prior art so that all base station signals are fed to all sectors, interference patterns result which gives rise to unreliable communication in overlap regions 28a, 28b and 28c between adjacent sectors.

The prior art installation 10 has a number of disadvantages as follows:
1. a three or six sector installation with beam widths of 120 or 60 degrees cannot be optimised to cover a line or rectangular grid of users;
2. a three, or six, sector installation does not allow convenient mounting of antennas flush with the sides of a rectangular building. A triangular gantry must be mounted on a building roof; alternatively, three antennas may be mounted on three sides of a building with two of them angled away from the third to meet the 120 degree sector requirement. In either case it is visually intrusive;
3. decreasing the power level to a sector to minimise inter-cell interference reduces the information capacity of the installation without allowing the power saving to be re-allocated to another sector; and
4. the number of optimisation parameters available for the installation 10 is not sufficient to optimise coverage.

Referring now to FIG. 2, an antenna installation 40 of the invention includes a base station 42 having ports 44a to 44n for connection to an N sector antenna structure 46 where N is 8 as illustrated, but can be any positive integer from 1 upwards. The antenna structure 46 has antenna sectors indicated by circular beam patterns 1A, 1B, 2A, 2B, 3, 4, N(A) and N(B) defined by respective antennas ANT 1A, ANT 1B, ANT 2A, ANT 2B, ANT 3, ANT 4, ANT (N)A and ANT (N)B. Chain lines defining split signal sectors N(A) and N(B) indicate that N is an arbitrary number as previously indicated, and selectable in accordance with any particular antenna installation requirement. Characters A or B after a numeral 1, 2 or letter N (in parenthesis in the case of N(A) and N(B)) indicate sectors which will receive the same (split) base station signals (as will be described later), and absence of these characters indicates sectors which will receive unsplit signals. The antennas ANT 1A etc. may be on the sides of a building or antenna gantry 48. A reference field strength line 50 (chain line) is shown which corresponds to the coverage area of an installation without signal splitting.

The base station 42 has sectors 1 to N each having one or more ports per antenna sector 1A, 1B, 2A, 2B, 3, 4, N(A) and N(B). The ports are labelled (not shown) TX for transmit, and RX for receive. It is common to use a single TX/RX port for both transmit and receive. It is also common to implement polarisation diversity with an antenna having separate ports for plus and minus 45 degree polarisations. Base station ports which are associated with an individual polarisation may be labelled TX(+)/RX(+) and TX(−)/RX(−). Strictly speaking signals have arbitrary polarisation within an antenna installation, i.e. before transmission from or after reception by an antenna, but it is convenient to refer to signals within the installation 40 and later embodiments as being polarised because they are associated with a polarisation at an antenna when later transmitted or earlier received. The invention is equally applicable to base stations with a single port for both transmit and receive signals and also to those with separate transmit and receive ports.

The base station ports are connected via jumper leads such as 52 to respective inputs (not shown) of a Sector Splitting and Combining Unit (SCU). In the conventional installation 10, base station signals pass to respective antenna sectors: in the installation 40 of the invention, at least one signal (three as illustrated), which would otherwise pass to a respective antenna sector, is split by the SCU into signals which pass to respective split signal sectors such as 1A and 1B. Base station signals that are not split pass through the SCU unchanged.

Output signals from the SCU are connected via jumper leads such as 54 to respective inputs (not shown) of a Coverage Control Unit (CCU), which is an optional item in this embodiment. The CCU may have one or more of the following functions:
1. distributing signal power to split signal sectors in any ratio, within the constraint that the total power to split signal sectors is unchanged (ignoring small unavoidable losses of less than 1 dB arising from non-ideal components);
2. dividing the already split signals between two or more signal paths for the purposes of pan and tilt control of the split signal sectors; and
3. applying pan and tilt control to unsplit signals passing to antenna sectors 3 and 4.

As drawn the CCU has a left hand column 56₁ of indicia 1AA, 1AB, 1BA, 1BB etc.: these indicate that CCU column 56₁ is splitting signals intended for split signal sectors 1A and 1B into pairs of signals 1AA/1AB and 1BA/1BB respectively.

Chain lines 58 associated with the base station 42, SCU and CCU indicate that they can be used for arbitrary numbers of antenna sectors 1A etc. selectable in accordance with any particular antenna installation requirement.

The antenna structure 46 is configured such that split signals which are derived from the same base station sector (e.g. 44a) are fed to antenna sectors which are not adjacent to one another and which therefore do not overlap significantly: these split signal sectors are in pairs in this example prefixed with the same numeral, and they are indicated by radiation or beam patterns 1A/1B 2A/2B, N(A)/N(B). Avoidance of overlap of split signals from a common base station sector avoids creation of signal interference regions in antenna coverage areas which would lead to signals being unobtainable in some areas. Split signal sectors (e.g. 1A, 1B) associated with the same base station sector are in this example separated from one another by at least one other antenna sector: e.g. split signal sectors 1A and 1B are separated from one another clockwise by sectors 2A, N(B) and 3 and anti-clockwise by sectors N(A), 2B and 4. It is not essential for split signal sectors 1A and 1B to be separated by other sectors, for an installation might only have two split signal sectors if 360 degree coverage was not required. For practical purposes, the criterion for absence of substantial overlap is that split signal antennas transmitting the same signal are sufficiently isolated from one another that any interference between their signals due to overlap is at signal strengths sufficiently small to have a negligible effect on communications with a user's handset.

As has been said, the SCU implements a first level of splitting. The CCU may, optionally, implement second and third levels of splitting, of which FIG. 2 only indicates the second level. These splitting levels give rise to SCU and CCU output signals labelled as shown in Table 1.

TABLE 1
Split Signal Labels

| | Split Signal Labels | | |
|---|---|---|---|
| | 1st Level | 2nd Level | 3rd Level |
| Sector | SCU Split | CCU Split | CCU Split |
| 1 | 1A | 1AA, 1AB | 1AAA, 1AAB, 1ABA, 1ABB, |
| | 1B | 1BA, 1BB | 1BAA, 1BAB, 1BBA, 1BBB |
| 2 | 2A | 2AA, 2AB | 2AAA, 2AAB, 2ABA, 2ABB, |
| | 2B | 2BA, 2BB | 2BAA, 2BAB, 2BBA, 2BBB |
| 3 | 2A | 3AA, 3AB | 3AAA, 3AAB, 3ABA, 3ABB, |
| | 3B | 3BA, 3BB | 3BAA, 3BAB, 3BBA, 3BBB |

To define a signal fully, its polarisation and TX or RX function is added in parenthesis so that the complete signal label becomes, for example, 1AAA-TX, 1AAA-RX(+), 1AAA-RX(−), etc. Although signal splitting into two is shown in FIG. 2, base station signals may be split into greater numbers to feed more than two split signal sectors.

The advantages of the installation 40 are:
1. antenna sectors 1A etc. may have any of a number of configurations that allow improved matching of antenna coverage to the requirements of the geographical area served by the installation 40;
2. antenna coverage improvements are obtained by instrumentation added externally to the base station 42 and without modification to it; and
3. additional hardware costs can be small in comparison with adding a further base station to the prior art installation described with reference to FIG. 1.

For convenience of description, some embodiments of the invention are described herein in which each base station port is used for both transmit and receive signals. If a base station has separate transmit and receive ports, then signal splitting hardware used for transmit signals may be duplicated for receive signals. However, an improved up-link carrier-to-noise ratio (CNR) is obtained if the receive signals from the split sectors are not combined and this advantage is obtainable with any of the embodiments described herein. For convenience of description and to reduce drawing complexity, some embodiments described herein only have one antenna polarisation. A common practice is to use a dual polarisation antenna, in which case these embodiments apply equally to the second polarisation. The hardware used for one polarisation is a duplicate of that used for the other polarisation. Embodiments of the invention may also be used with antennas using Tower Mounted Amplifiers (TMAs) and associated filters. They may conveniently use sector antennas closely mounted on an antenna gantry, or mounted flush, or largely unnoticeably, on the sides of a building with consequent reduction in visual impact on the environment.

In all embodiments described herein antenna beam width is defined as beam width to points 10 dB below antenna boresight gain. Signal splitting equipment is shown located with, or near, each associated base station so that antenna parameters (setting antenna coverage) may conveniently be set without access to an antenna mast or gantry or an antenna itself. However, signal splitting equipment may be co-located with antenna if convenient, i.e. if antenna parameters do not require adjustment after initial installation. If so, there will be a reduction in the number of signal feeders between the base station and the antenna assembly.

Referring now to FIG. 3, a second antenna installation 70 of the invention is shown which is arranged for signal splitting once more. It is equivalent to the installation 40 described with reference to FIG. 2, with certain elements simplified or omitted. Its description will concentrate on aspects of difference. Parts equivalent to those described earlier are like-referenced.

The installation 70 has four antennas ANT 1A, ANT 1B, ANT 2 and ANT 3 giving rise to four antenna coverage sectors 1A, 1B, 2 and 3. The antennas ANT 1A and ANT 1B are split signal antennas with 60 degree beam width, and the other antennas ANT 2 and ANT 3 have 120 degree beam width. These antennas are mounted on respective sides of a rectangular building or gantry 48. The SCU receives three signals 1, 2 and 3 from the base station 42. Using a splitter/combiner SC1, it splits signal 1 into two signals 1A and 1B of equal power level each 3 dB less than signal 1. The splitter/combiner SC1 acts as a splitter in transmit mode for outgoing signals and a combiner in receive mode for incoming signals. The signals 1A, 1B, 2 and 3 are connected to antennas ANT 1A, ANT 1B ANT 2 and ANT 3 respectively, i.e. there is no intervening CCU. There is a degree of overlap between adjacent sectors at regions 56.

Reducing antenna beam width from 120 degrees to 60 degrees provides a 3 dB increase in boresight gain in split signal sectors 1A and 1B compared to sectors 2 and 3. The net effect is that the maximum field strength of the split signal sectors 1A and 1B is the same as in sectors 2 and 3. This ignores losses in the splitter/combiner SC1 due to non-ideal properties, which are negligible and typically 0.3 dB.

The antenna installation 70 has the following advantages:
1. the sectors 1A, 1B, 2 and 3 have rectangular grid symmetry because of the antenna mounting geometry, and will be well matched to urban road and rail systems if they have like symmetry;
2. the additional cost of the splitter/combiner SC1 and fourth antenna and its feeder are low in comparison with the cost of the prior art three antenna installation 10;
3. the antenna coverage improvement requires no modification to the base station 42;
4. either one of or both electrical and mechanical tilt can be applied independently to beams of antenna 1A and antenna 1B providing further options for optimisation of antenna coverage;
5. split signal sectors 1A and 1B do not carry the same signals as their adjacent sectors 2 and 3 and hence interference patterns are not generated in overlap regions 56;
6. split signal antennas 1A and 1B have ports (not shown) which are separated by twice the front-to-back ratio, typically 25 dB, of the antennas: this gives an isolation of at least twice the front-to-back ratio, amounting typically to 50 dB of isolation between these antennas when measured at their ports. Consequently, coupling between these antennas is negligible even when mounted closely on the same gantry 48; and
7. antennas 1A, 1B, 2 and 3 are not required to be angled obliquely with respect to sides of the building or gantry 48; instead they may be mounted flush on the sides of a square building, and also they may be inconspicuously mounted integrally with such a building.

Referring now to FIG. 4, a third antenna installation 80 of the invention is shown which is arranged for signal splitting once more, but also to cover a non-uniform distribution of users. It is equivalent to the installation 70 described with reference to FIG. 3, with certain elements modified. Its description will concentrate on aspects of difference. Parts equivalent to those described earlier are like-referenced.

The installation 80 has four antennas ANT 1, ANT 2, ANT 3A and ANT 3B giving rise to four antenna coverage sectors 1, 2, 3A and 3B. Contrary to the earlier embodiment, it is now antennas ANT 1 and ANT 2 which have 60 degree beam width, and split signal antennas ANT 3A and ANT 3B which have 120 degree beam width. As before, the SCU receives three signals 1, 2 and 3 from the base station 42. However, the splitter/combiner SC1 is now located in the signal 3 path from the base station 42, not that of signal 1: it splits signal 3 into two signals 3A and 3B of equal power level 3 dB less than signal 1. The signals 1, 2, 3A and 3B are connected to antennas ANT 1, ANT 2, ANT 3A and ANT 3B respectively.

Reducing antenna beam width from 120 degrees to 60 degrees provides a 3 dB increase in boresight gain in sectors 1 and 2. Split signal sectors 3A and 3B have 3 dB lower transmit power due to splitter SC1, and also a 3 dB lower sensitivity to receive signals due to vector combining of asynchronous receive signals in splitter SC1. These power parameters are shown by bi-directional arrows 82 indicating differences between the horizontal radiation pattern of the sector antennas and the reference field strength line 50. The net effect is that the maximum field strength of the split signal sectors 3A and 3B is 6 dB less than in sectors 1 and 2, ignoring losses in the splitter/combiner SC1. Sectors 1 and 2 consequently have increased coverage compared to split signal sectors 3A and 3B and also compared to the prior art 120 degree beam width antennas. Coverage can therefore be optimised by appropriate selection of antenna beam width.

Referring now to FIG. 5, a fourth antenna installation 100 of the invention is shown which is arranged for signal splitting and covering a non-uniform distribution of subscribers once more, but using antennas with equal beam widths. It is equivalent to the installation 70 described with reference to FIG. 3, with the sole exception that its four antennas ANT 1A, ANT 1B, ANT 2 and ANT 3 all have 90 degree beam width. Its description will concentrate on aspects of difference. Parts equivalent to those described earlier are like-referenced. The effect of using antennas of equal beam width is that there is 3 dB difference in power supplied to split signal sectors 1A and 1B compared to sectors 2 and 3, but all four antennas ANT 1A etc. have the same boresight gain. The power 3 dB difference is indicated by arrows 82 showing separations of +1.25 dB and −1.75 dB of horizontal radiation patterns 84 and 86 relative to reference field strength line 50.

Referring now to FIG. 6, there is shown a modification 110 to part of the SCU described earlier to provide control over transmitter down link power distribution and receiver sensitivity. The modification 110 will be referred to as a power distribution module. The splitter/combiner SC1 implements splitting into two signals of equal power, and has a first output SC1x connected to a first input Ha of a 180 degree hybrid coupler H. It has a second output SC1y connected to a first transmit/receive duplex filter F1d: the filter F1d has a transmit output F1dt and a receive input F1di connected to transmit and receive time delay devices T1 and T2 respectively. A second transmit/receive duplex filter F2d has a transmit input F2dt and a receive output F2di connected to the time delay devices T1 and T2 respectively, and a single input/out line Lio connected to a second input Hb of the coupler H. The coupler H has sum and difference outputs S and D which provide transmit signals to and obtain receive signals from split signal sectors 1A and 1B. It provides transmit signal outputs at S and D which are the vector sum and difference of the signals on its inputs Ha and Hb.

If the phase difference is zero between transmit signals reaching input Ha and Hb from the splitter/combiner SC1 and the first transmit/receive duplex filter F1d, the coupler sum output at S is a maximum, and the difference output at D is zero. As the phase shift between these transmit signals increases, sum output power falls and difference output power increases. When the phase difference these transmit signals is 180 degrees, the sum output is zero while the difference output is a maximum. In consequence, the relative power levels supplied to split signal sectors 1A and 1B are variable by changing this phase difference, which is implemented using the transmit time delay device T1. The hybrid coupler H, duplex filters F1d and F2d and the splitter/combiner SC1 operate in the same way in receive mode, albeit in reverse, and the time delay between receive signals at Ha and Hb (now hybrid coupler outputs) is implemented using the receive time delay device T2. Because the time delay devices T1 and T2 are connected between transmit and receive duplex filters F1d and F2d, they can be set independently to control both the relative transmitter power and the relative receiver sensitivity in split signal sectors 1A and 1B. The duplex filters F1d and F2d may be omitted, and a single time delay device used instead of T1 and T2, if it is not required to set transmit power and receive sensitivity independently.

Referring now to FIG. 7, the power distribution module 110 is shown incorporated in an SCU of a fifth antenna installation 120, which has split signal antennas ANT 1A and ANT 1B with 60 degree beam width and sector antennas ANT 2 and ANT 3 with 120 degree beam width. The installation 120 is otherwise equivalent to the installation 100 described with reference to FIG. 5 and will not be described in detail. Parts equivalent to those described earlier are like-referenced.

Transmit power fed to split signal antenna ANT 1A is adjustable relative to that fed to split signal antenna ANT 1B by varying transmit time delay device T1 in module 110, but the total transmitted power to these antennas remains constant. Similarly, receive sensitivity is adjustable by varying transmit time delay device T2. Consequently the split signal sector 1A or 1B having either larger geographical area or greater communications traffic requirement can then be set with a higher power or sensitivity than the other split signal sector 1B or 1A. This provides a further degree of freedom for optimising sector coverage to add to the established techniques of varying electrical and mechanical antenna tilt.

Referring now to FIG. 8, a sixth antenna installation 140 is shown, and parts equivalent to those described earlier are like-referenced. The installation 140 has split signal antennas ANT 1A and ANT 1B and antenna ANT 2 all with a narrow beam width, 60 degrees as illustrated but alternatively 30 degrees, and sector antenna ANT 3 with omni-directional coverage. Consequently, there is no overlap between split signal sectors 1A, 1B and sector 2, but split signal sectors 1A, 1B and sector 2 are superimposed on or overlaid on to sector 3. The installation 120 is otherwise equivalent to the installation 100 described with reference to FIG. 5 and will not be described in detail. The installation 140 is suitable for road or rail intersection having a ‘T’ topology covered by split signal sectors 1A, 1B and sector 2, and combined with local area urbanisation and traffic covered by the omni-directional antenna 3.

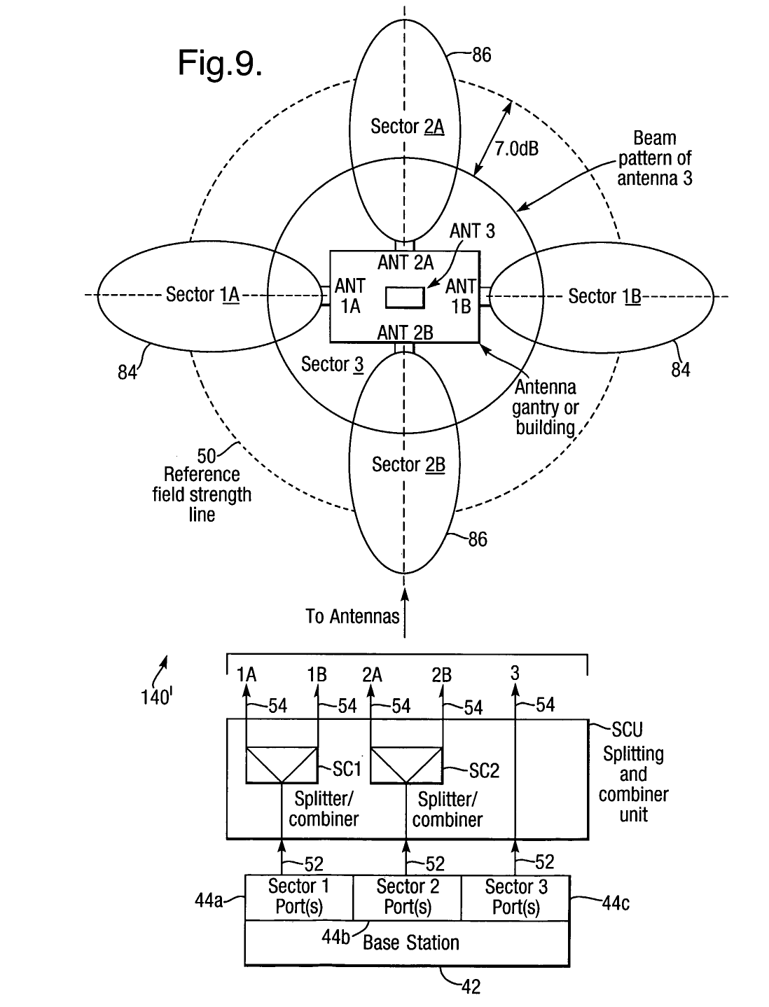

FIG. 9 shows a modified version 140′ of the installation 140. Here an additional splitter/combiner SC2 is introduced to split the second base station signal 2 into signals 2A and 2B, and sector antenna ANT 2 is replaced by split signal antennas ANT 2A and ANT 2B receiving signals 2A and 2B respectively. The installation 140′ is suitable for use with the antenna ANT 3 serving a local area, and split signal sectors 1A, 1B, 2A and 2B serving a road or rail system laid out on a rectangular grid. The split signal antennas ANT 1A, ANT 1B, ANT 2A and ANT 2B have narrow beam width, and hence high gain, and substantially confine their coverage to the road system. The installation 140′ is otherwise equivalent to the installation 140 and will not be described further.

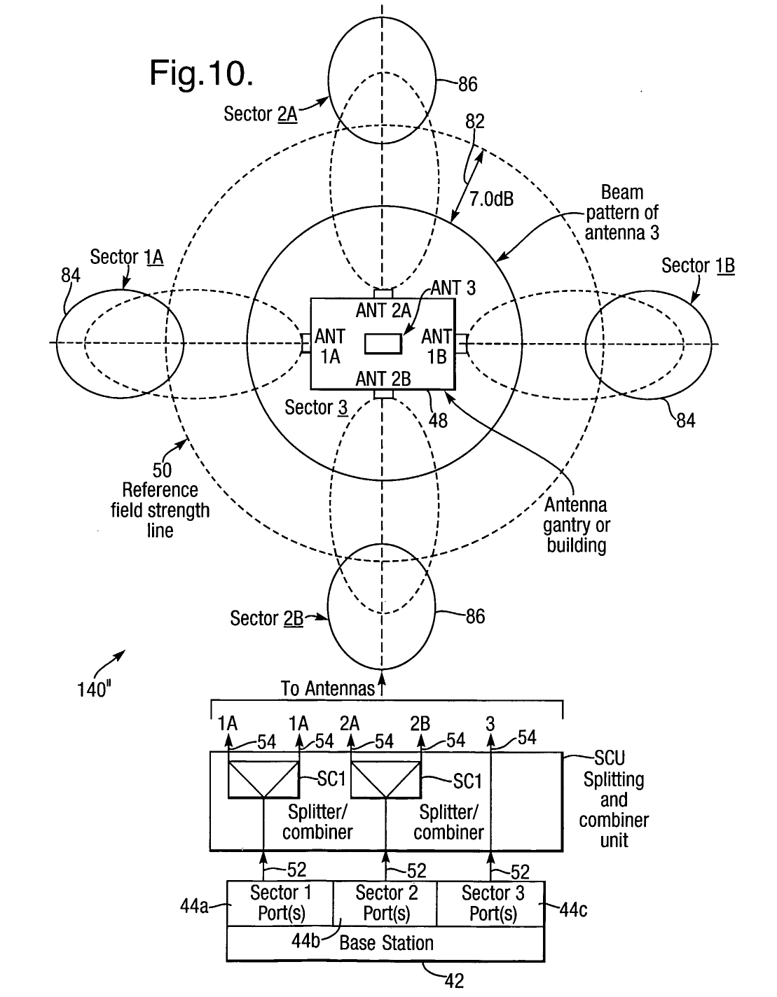

Referring now to FIG. 10, this shows a further modified version 140″ of the installation version 140′. In the modified version 140″, the coverage provided by split signal antennas ANT 1A, ANT 1B, ANT 2A and ANT 2B directed predominantly outside of the coverage of the omni-directional antenna ANT 3. This effect is achieved by using narrow horizontal and vertical beam width antennas for ANT 1A, ANT 1B, ANT 2A and ANT 2B, and controlling antenna tilt appropriately. The modified version 140″ is otherwise equivalent to version 140′.

FIG. 11 shows a split and delay module 150 for implementation of either of or both of antenna pan and antenna tilt of split signal sectors in a CCU described with reference to FIG. 2. A signal 1A on an input 152 is split into two signals 1AA and 1AB of equal amplitude by a splitter/combiner SC3. One of these signals 1AB is then delayed, or phase shifted, relative to the other by a variable delay device T3, and both signals are then output to antenna split signal sector 1A (not shown). Similar modules 150 are used for other antennas in FIG. 2.

Referring now to FIG. 12, a further antenna installation 160 of the invention is shown which incorporates the split and delay module 150 for implementation of antenna tilt, i.e. setting the inclination of an antenna beam with respect to the vertical. Parts equivalent to those described earlier are like-referenced. The installation 160 is equivalent to the installation 70 described with reference to FIG. 3, with the sole exception that signals 1A and 1B output from the splitter/combiner SC1 are further split into relatively phase shifted signal pairs 1AA/1AB and 1BA/1BB by respective split and delay modules 150 before these pairs are fed to respective split signal antennas ANT 1A and ANT 1B. For convenience, unlike FIG. 2, the split and delay modules 150 are incorporated in the SCU. It is assumed that each of the antennas ANT 1A and ANT 1B are now of the kind that has two ports and an angle of electrical tilt can be set by the phase difference between signals applied to its ports. This implements remotely and independently adjustable electrical tilt in split signal sectors 1A and 1B. Published International Patent Application No. WO 03/036756 discloses an angle of electrical tilt that is remotely adjustable by the phase difference between two antenna inputs.

The installation 160 allows coverage provided by split signal sectors to be optimised. If only one split signal sector requires remotely adjustable electrical tilt, one of the split and delay modules 150 may be omitted.

Referring now to FIG. 13 a further antenna installation 170 of the invention is shown which incorporates the split and delay module 150 for implementation of antenna pan, i.e. movement of an antenna beam in a horizontal plane. Parts equivalent to those described earlier are like-referenced. The installation 170 is equivalent to the installation 160 with the sole exception that split signal antennas ANT 1A and ANT 1B receiving signal pairs 1AA/1AB and 1BA/1BB are now of the kind that has two ports and an angle of electrical pan that can be set by the phase difference between signals applied to its ports. This allows split signal sectors 1A and 1B to be panned between positions indicated by adjacent pairs of dotted circles 172 and bi-directional arrows 174. The antennas ANT 1A and ANT 1B have two or more vertical antenna element stacks each of which is a phased array antenna assembly. The antenna beams may be panned by adjusting the relative phase to the vertical stacks. The installation 170 allows antenna coverage to be adjusted to accommodate a geographical distribution of users which is not uniform. This would occur, for example, where a major road highway is curved rather than straight.

FIG. 14 shows an antenna installation 180 of the invention which provides an improved up-link received Carrier-to-Noise Ratio (CNR) for split signal sectors. It is equivalent to the installation 70 described with reference to FIG. 3, with the SCU modified. Its description will concentrate on aspects of difference. Parts equivalent to those described earlier are like-referenced.

The base station 42 has a transmit port 182a common to split signal sectors 1A and 1B, but separate receive ports 182b and 182c for these sectors. Transmit/receive ports 44b and 44c for sectors 2 and 3 are as described earlier.

The SCU has first and second duplex filters FL1 and FL2 which separate signals passing to and from base station ports 182a, 182b and 182c. A transmit signal from the transmit port 182a is split by the splitter/combiner SC1 into two signals which pass to transmit channels TX of the first and second duplex filters FL1 and FL2, and thence to split signal antennas ANT 1A and ANT 1B respectively. Receive signals returning from these antennas pass to receive channels RX of these filters, and thence to base station receive ports 182b and 182c respectively.

In earlier embodiments, receive signals from split signal sectors 1A and 1B were combined by the splitter/combiner SC1 before connecting to a single base station port 44a. The receive signals from these sectors were asynchronous, i.e. they did not match in either magnitude or phase, and consequently there was a 3 dB vector combining loss in the splitter/combiner SC1 These receive signals now bypass the splitter/combiner SC1 and are fed to respective base station receive ports 182b and 182c. The 3 dB vector combining loss for split signal sector receive signals is avoided by this means. Furthermore, the use of 60 degree antennas for the split signal sectors 1A and 1B, as opposed to the 120 degree antenna used for sectors 2 and 3, gives a 3 dB improvement in directivity gain as mentioned earlier. The combination of avoiding the 3 dB vector addition loss and the 3 dB directivity gain improvement means that the total up-link gain improvement for sectors 1A and 1B is 6 dB.

In a cellular installation it is generally the up-link that is disadvantaged due to lower Effective Radiated Power (ERP) of a subscriber's handset compared to the ERP of a base station antenna installation. ERP is the product of transmitter power and antenna directivity gain, less any losses. The handset is thus doubly disadvantaged in having both a lower transmit power and a substantially non-directional antenna. A 6 dB improvement in the up-link direction thus results in significant improvements in the up-link communications performance and in handset battery life. This provides an advantage in rural areas where increased up-link performance allows base stations to be more widely spaced. The modification of introducing filters FL1 and FL2 as shown in FIG. 14 may be incorporated in any embodiment of the invention.

Referring now to FIG. 15, an antenna installation 200 of the invention is shown which provides transmit polarisation diversity. It is equivalent to the installation 70 described with reference to FIG. 3 with the SCU modified once more. Its description will concentrate on aspects of difference. Parts equivalent to those described earlier are like-referenced. It is assumed that each of the antennas ANT 1A and ANT 1B is now of the kind that has different ports for input of different polarisation signals.

The base station 42 has six ports 202a to 202e: of these, first and second ports 202a and 202b respectively provide positive (+) and negative (−) polarisation transmit signals for split signal sectors 1A and 1B. These transmit signals are each split into equal power signals by a respective splitter/combiner SC1, SC2. Splitter SC1 provides signals for positive polarisation inputs of antennas ANT 1A and ANT 1B, whose negative polarisation inputs receive signals provided by splitter SC2. In a multi-path propagation environment, transmit diversity (and also receive diversity) gives a further improvement in coverage and capacity. Receive diversity can be implemented similarly.

FIG. 16 shows an antenna installation 220 of the invention which is intended to provide increased power to split signal sectors. It is equivalent to the installation 180 described with reference to FIG. 14 with the SCU modified once more. Parts equivalent to those described earlier are like-referenced.

The difference between the installations 180 and 220 is that power amplifiers PA1 and PA2 are inserted in respective transmit signal paths from splitter/combiner SC1 to transmit channels of filters FL1 and FL2. The introduction of these power amplifiers requires receive signals to be separated from transmit signals in the filters FL1 and FL2, which then gives an up-link improvement as described earlier. The power amplifiers PA1 and PA2 provide transmit signals with increased power to split signal sectors 1A and 1B, which allows these split signal sectors to cover either:
1. the same geographical area as the installation 180 without power amplifiers but with increased traffic throughput; or
2. an extended geographical area while maintaining traffic throughput.

The increased power level in split signal sectors 1A and 1B also introduces an option of decreasing the beam width of the associated antennas ANT 1A and ANT 1B to improve coverage further. The installation 220 allows both up-link and down-link coverage and capacity to be increased, avoiding the need for a second base station.

Referring now to FIG. 17, an antenna installation 240 of the invention is shown which provides transmit diversity and antenna sharing by different base station operators, while also providing for signal splitting as in earlier embodiments. It is assumed that no two operators are using adjacent frequencies which are contiguous, i.e. that cannot be separated by conventional filters having a practically realisable attenuation gradient as a function of frequency. The installation 240 combines different operator signals while avoiding use of a hybrid combiner introducing a 3 dB power loss. Use of such a combiner is a common feature of the prior art.

The installation 240 is employed with a base station (not shown) which has twelve ports, six transmit ports and six receive ports. It is for use by three operators in this example, but the number of operators can be greater than this. Each operator has two respective transmit ports for transmitting positive (+) and negative (−) polarisation signals separately and two respective receive ports for receiving such signals separately. The positive polarisation transmit and receive ports of all three operators are linked by connections 242 to a first combining filter CF1: this filter contains positive polarisation transmit band pass filters FTX1(+), FTX2(+) and FTX3(+) with pass bands centred on respective operator frequencies and connected to corresponding transmit ports. It also contains a single positive polarisation receive band pass filter FRX(+) with a pass band sufficiently wide to encompass all three operator frequencies. The receive band pass filter FRX(+) is connected to a positive polarisation three way splitter SP1(+) providing output signals to respective base station operator receive ports.

The positive polarisation transmit and receive band pass filters FTX1(+), FTX2(+), FTX3(+) and FRX(+) are connected to a two way splitter SP2(+) having output lines 244A(+) and 244B(+): these output lines are connected to positive polarisation ports P1A+ and P1B+ of two split signal antennas ANT 1A and ANT 1B. These antennas and two others ANT 2 and ANT 3 are mounted on respective sides of a rectangular support SR.

The installation 240 has equivalent components for negative polarisation, i.e. a second combining filter CF2 with transmit and receive band pass filters FTX1(−), FTX2(−), FTX3(−) and FRX(−), of which the last is connected to a three way splitter SP1(−) providing signals to base station operator receive ports. The filters FTX1(−), FTX2(−), FTX3(−) and FRX(−), are connected to a two way splitter SP2(−) having output lines 244A(−) and 244B(−): these output lines are connected to negative polarisation ports P1A− and P1B− of the split signal antennas ANT 1A and ANT 1B.

Operation of the installation 240 is as follows. In transmit mode, positive and negative polarisation signals from the base station pass via respective sets of transmit band pass filters FTX1(+) etc. and FTX1(−) etc. to provide positive and negative polarisation inputs to the split signal antennas ANT 1A and ANT 1B. The transmit band pass filters FTX1(+) etc. and FTX1(−) etc. allow low loss combining of the transmit and receive signals, and they also inhibit transmit signals from one operator transmitter at the base station passing to another such transmitter and causing de-sensitisation of the base station receivers from unwanted intermodulation (frequency mixing) products.

In receive mode, positive and negative polarisation signals pass from split signal antennas ANT 1A and ANT 1B, and positive polarisation signals are combined by splitter SP2(+) acting reversibly as a combiner. Similarly negative polarisation signals from these antennas are combined by splitter SP2(−). The positive and negative polarisation signals are filtered by receive band pass filters FRX(+) and FRX(−) and are then split at SP1 (+) and SP1 (−) respectively: this provides positive and negative polarisation receive signals to the base station for each operator. Receive signal inputs at the base station are selectively received enabling operators to filter their own signal frequencies from the three receive signal frequencies each receives. The installation 240 demonstrates that the signal splitting and split signal antenna technique of the invention can be used when antennas are shared by multiple operators.

Referring now to FIG. 18, an antenna installation 260 of the invention is shown which is arranged for transmit diversity and low loss combining, with two operators sharing antennas and using contiguous frequencies: here contiguous frequencies are those which are so close together that they cannot be separated by conventional filters having practically realisable attenuation gradient as a function of frequency.

The installation 260 is equivalent to that described with reference to FIG. 17 with the number of operators reduced to two and the SCU(P) replaced by a hybrid splitting and combiner unit HSCU. The reduction in the number of operators is for convenience of illustration, as more operators can be accommodated as will be described later. The description of the installation 260 will concentrate on differences compared to FIG. 17. Parts equivalent to those described earlier are like-referenced.

Positive polarisation operator signals from a base station (not shown) are fed to respective inputs ln(1)a and ln(2)a of a 180 degree first hybrid coupler (hybrid) H1 in the HSCU. Here they are added to and subtracted from one another to provide sum and difference signals at outputs Sa and Da respectively. The sum output Sa of the first hybrid H1 is connected to the positive polarisation port P1A+ of the antenna ANT 1A, and the difference output Da of this hybrid is connected to the positive polarisation port P1B+ of the antenna ANT 1B. Consequently the ports P1A+ and P1B+ receive positive polarisation input signals in transmit mode. Similarly negative polarisation operator signals are formed by a second hybrid H2 into sum and difference signals and fed to negative polarisation ports P1A− and P1B− respectively. The hybrids H1 and H2 are reversible, so in receive mode they operate in the same way in the reverse direction to provide individual operator signals.

In the up-link direction received signals incur a 3 dB loss due to being split into two paths by the hybrids H1 and H2. This loss is recovered by the 3 dB increase in directivity of split signal antennas ANT 1A and ANT 1B, i.e. 60 degrees beam width instead of 120 degrees. A further improvement in the up-link performance may be obtained by using the technique described with reference to FIG. 14. The installation 260 provides the coverage benefit of the spilt signal method of the invention, while at the same time combining signals from a plurality of operators. The operator signals may have contiguous frequencies and both operators may use transmit diversity as well as receive diversity, in accordance with embodiments described earlier.

Referring now to FIG. 19, an antenna installation 280 of the invention is shown which is arranged for low loss signal combining with four operators sharing antennas and using contiguous frequencies. The installation 280 is equivalent to that described with reference to FIG. 18 with the number of sharing operators Op. 1 to Op. 4 increased to four and their signals combined or split using a filter/splitter assembly 282. It provides receive diversity but not transmit diversity.

The filter/splitter assembly 282 has four transmit/receive filter units 284a to 284d each containing a respective TX filter and RX filter, of which the latter is connected to a respective two way splitter 286a, 286B, 286c or 286d. Each of the operators Op. 1 to Op. 4 has a single transmit port (not shown) associated with either a positive or a negative polarisation antenna transmit signal, i.e. TX(+) or TX(−) as shown, but not both. Each operator Op. 1 etc. also has two receive ports (not shown) for receipt of positive and negative polarisation receive signals, i.e. RX(+) and RX(−) respectively as shown, and providing for receive diversity.

In transmit mode, transmit signals from first and second operators Op. 1 and Op. 2 are TX filtered at 284a and 284b respectively. They are then combined by the first hybrid H1 and fed as sum and difference signals to the positive polarisation ports P1A+ and P1B+ of split signal antennas ANT 1A and ANT 1A. Likewise, the negative polarisation ports P1A− and P1B− of these antennas receive transmit signals from third and fourth operators Op. 3 and Op. 4 after filtering at 284c and 284d and combining by the second hybrid H2.

In receive mode, receive signals from positive polarisation antenna ports P1A+ and P1B+ are combined by the first hybrid H1 and passed as sum and difference signals for RX filtering at 284a and 284b. Likewise, composite receive signals from the negative polarisation antenna ports P1A− and P1B− are combined by the second hybrid H2 and passed as sum and difference signals for RX filtering at 284c and 284d. Each of the four resulting filtered composite receive signals is then split into two at a respective one of splitters 286a to 286d. Split receive signals from the first splitter 286a pass to RX(+) input ports of the first and fourth operators Op. 1 and Op. 4. Split receive signals from the second splitter 286b pass to RX(+) input ports of the second and third operators Op. 2 and Op. 3. Split receive signals from the third splitter 286c pass to RX(−) input ports of the second and third operators Op. 2 and Op. 3. Split receive signals from the fourth splitter 286d pass to RX(−) input ports of the first and fourth operators Op. 1 and Op. 4.

In the up-link direction received signals incur a 6 dB loss due to being split into two paths by the hybrids H1 and H2 and further split two ways at splitters 286a to 286d. This is in order to enable each operator to have access to both polarisations of the receive signals. The 6 dB loss is reduced to a 3 dB loss by the increased gain of the 60 degree antennas ANT 1A and ANT 1B, or eliminated if 30 degree antennas are used. Alternatively, if Tower Mounted Amplifiers (TMAs) are incorporated into the antenna assembly 280, then the effect of the 6 dB splitting loss can be removed while retaining a 120 degree antenna. Furthermore, if TMAs are used in conjunction with split signal antennas of narrower beam width than 120 degrees, and hence higher directivity gain, the installation 280 then gives an up-link improvement in accordance with the increased directivity.

Referring now to FIG. 20, an antenna installation 300 of the invention is shown which is arranged for low loss signal combining with five operators sharing antennas. Operators of the installation 300 may have contiguous frequencies and both transmit polarisation diversity and receive polarisation diversity are provided. The installation 300 is equivalent to that described with reference to FIG. 19 with the number of sharing operators increased to five and, together with their frequencies, referenced 1 to 5. Operator signals are combined or split using a filter/splitter assembly 302 which is a modified version of the assembly 282 having additional transmit filters TX to cope with additional signals and diversity. Parts equivalent to those described earlier are like-referenced.

For the purposes of this embodiment, it is assumed that the operator frequencies are in the sequence 1, 2, 3, 4 and 5, i.e. frequency 2 is contiguous with frequencies 1 and 3, frequency 3 is contiguous with frequencies 2 and 4 and frequency 4 is contiguous with frequencies 3 and 5. Consequently odd numbered frequencies 1, 3 and 5 form a first non-contiguous frequency group and even numbered frequencies 2 and 4 form a second non-contiguous frequency group.

A base station (not shown) has five transmit ports TX and five receive ports RX for each of two polarisations, positive and negative polarisations as indicated at 304(+) and 304(−). This provides each operator with four ports, i.e. transmit and receive ports TX and RX for each polarisation. The filter/splitter assembly 302 has four combining filters 306a to 306d containing a receive filter RX together with either two or three transmit filters TX. In transmit mode, the first non-contiguous frequency group of transmit signals (odd frequencies 1, 3 and 5) with positive and negative polarisations are fed to first and third combining filters 306a and 306c respectively. Likewise, the second non-contiguous frequency group (even frequencies 2 and 4) with positive and negative polarisations are fed to second and fourth combining filters 306a and 306c respectively: all these ten transmit signals are band pass filtered at TX1 etc. and then transmit signals from each combining filter 306a, 306b, 306c or 306d are combined on to a single respective TX filter output line 308a, 308b, 308c or 308d.

The positive polarisation transmit signals on first and second filter output lines 308a and 308b are combined by a first hybrid H1, and those with negative polarisation on third and fourth filter output lines 308c and 308d are combined by a second hybrid H2 for supply to split signal antennas ANT 1A and ANT 1B. In other respects the installation 300 operates as discussed earlier in connection with the embodiment described with reference to FIG. 19, albeit two two-way receive signal splitters 286a and 286c have become replaced by three-way receive signal splitters 310a and 310c to provide for the increase in operators from four to five. The number of operators may be increased by the addition of further combining filters 306.

FIG. 21 shows an antenna installation 320 of the invention which is intended to provide adjustable transmit power and receive sensitivity (power distribution). It is equivalent to the installation 300 described with reference to FIG. 20 with a filter/splitter assembly 322 which is a version of the assembly 302 modified to remove hybrids and substitute splitters and modules of the kind shown in FIG. 6. Its description will concentrate on aspects of difference. Parts equivalent to those described earlier are like-referenced.

The difference between the installations 320 and 300 is that, in the installation 320, all transmit signals from operators are of a single polarisation, and they are split into A and B signals by power distribution modules 110a or 110b (operators Op. 1 and Op. 3) or by equal power two-way splitters 324c to 324e (operators Op. 2, Op. 4 and Op. 5). The first non-contiguous frequency group of transmit signals (odd frequencies 1, 3 and 5) now has sub-groups of signals A and B which are fed to first and third combining filters 306a and 306c respectively. Likewise, the second non-contiguous frequency group (even frequencies 2 and 4) now has sub-groups of signals A and B which are fed to second and fourth combining filters 306a and 306c respectively: all these ten transmit signals are band pass filtered at TX1 etc. and then transmit signals from each combining filter 306a, 306b, 306c or 306d are combined on to a single respective TX filter output line 308a, 308b, 308c or 308d. Hybrid combiners are now unnecessary as these filter outputs have already been split and combined as required for input to split signal antennas ANT 1A and ANT 1B. In other respects the installation 320 operates as discussed earlier in connection with the embodiment described with reference to FIG. 20. This embodiment shows that the techniques of power distribution, pan and tilt, and signal splitting can be applied to a shared antenna installation.

Referring now to FIG. 22, an antenna installation 340 of the invention is shown which is equivalent to the installation 70 described with reference to FIG. 3 with the SCU modified to provide for antenna pan and tilt. Parts equivalent to those described earlier are like-referenced. A base station output signal at 44a is split by a splitter SC4 to provide equal amplitude signals 1A and 1B, which are supplied as inputs to two split and delay module modules 150A and 150B. These modules split the signals 1A and 1B into respective pairs of signals 1AA/1AB and 1BA/1BB to provide pan signals for split signal antennas ANT 1A and ANT 1B.

The pairs of signals 1AA/1AB and 1BA/1BB are each further split by respective ganged pairs of split and delay modules 150AA/150AB and 150BA/150BB, and this provides eight antenna input signals 1AAA, 1AAB, 1ABA, 1ABB, 150BM, 150BAB, 150BBA and 150BBB. Antenna input signals with references beginning 1A are input to split signal antenna ANT 1A, and antenna input signals with references beginning 1B are input to split signal antenna ANT 1B. These antennas are implemented as antenna stacks. Ganging together of input pairs 150iaa/150iab and 150iba/150ibb to module pairs 150AA/150AB etc. provides for all stacks in each of the antennas ANT 1A and ANT 1B to tilt together. This embodiment allows coverage of split signal sectors 1A and 1B to be controlled independently and simultaneously in both pan and tilt.

FIG. 23 shows an antenna installation 340 of the invention which incorporates features equivalent to those of the installations 320 and 340 described with reference to FIG. 21 and 22. It has an SCU which is modified to provide for some antennas to tilt and others to provide adjustable transmit power and receive sensitivity. Parts equivalent to those described earlier are like-referenced.

Base station transmit signals at 44a and 44b are fed to respective split and delay modules 150a and 150b: module 150a splits its signal into tilt signals 1a and 1b for supply to a first antenna ANT 1 and module 150b splits its signal into tilt signals 2a and 2b for supply to a second antenna ANT 2. The tilt signals 2a and 2b may alternatively be used as pan signals.

A third base station transmit signal at 44c is fed to a power distribution module 1103, which splits it into signals 3A and 3B. The signals 3A and 3B become input signals for split signal antennas ANT 3A and ANT 3B and provide adjustable transmit power and receive sensitivity.

Referring now to FIG. 24, a six sector shared antenna installation 400 is shown intended for sharing operators Op. 1 and Op. 2 having different sectorisation requirements. Operator Op. 1 has two base stations 42a and 42b each providing ports for a three sector antenna installation, and each port is connected to a respective antenna combining unit ACU. Operator Op. 2 has one base station 42c providing ports for a three sector antenna installation, and each of its port signals is split into two signals by a respective splitter SPa, SPb or SPc. This gives a total of six signals from the base station 42c, and each of these signals is connected to a respective antenna combining unit ACU. Each antenna combining unit ACU therefore receives one signal from each operator Op. 1 and Op. 2, and combines these signals for supply to respective shared antennas 380a to 380f.

FIG. 24 may be modified to provide four sector antenna sharing. If the operator Op. 1 has two base stations 42a and 42b each providing two outputs, and if only one of the operator Op. 2 outputs is split into two signals, then there are four signals from each operator, four antenna combining units ACU and four shared antennas.

1. An antenna installation for cellular radio including a signal splitter for splitting a base station signal into a plurality of split signals, and signal feeds for feeding the split signals to respective antennas, the antennas having beams which are sufficiently isolated from one another to provide for mutual interference to have negligible effect on communications performance.

2. An antenna installation according to claim 1 wherein the antennas are split signal antennas incorporated in an antenna assembly with other antennas of different gain.

3. An antenna installation according to claim 2 wherein not all of the antennas have the same beam width.

4. An antenna installation according to claim 2 wherein at least one of the other antennas has a beam which overlaps one or more sector or split signal antennas.

5. An antenna installation according to claim 1 including means for adjusting at least one of transmitted power and receiver sensitivity of an antenna relative to another antenna.

6. An antenna installation according to claim 1 including means for adjusting at least one of antenna electrical pan and tilt.

7. An antenna installation according to claim 1 including filtering means for separating receive signals and for routing them to different base station ports.

8. An antenna installation according to claim 1 wherein the antennas provide transmit diversity.

9. An antenna installation according to claim 1 including power amplifiers for amplifying split signals.

10. An antenna installation according to claim 1 including a signal combiner for combining a plurality of base station transmit signals in order to implement antenna sharing.

11. An antenna installation according to claim 10 providing transmit polarisation diversity.

12. An antenna installation according to claim 10 wherein the signal combiner comprises signal filtering apparatus or hybrid coupling apparatus.

13. An antenna installation according to claim 1 wherein the antennas are shared between four operators.

14. An antenna installation according to claim 13 providing receive polarisation diversity.

15. An antenna installation according to claim 1 wherein the antennas are shared between a plurality of operators using contiguous signal frequencies, the installation having means for separating the signals into groups with non-contiguous frequencies, means for combining grouped signals and means for combining the groups to enable antenna sharing.

16. An antenna installation according to claim 15 providing transmit diversity.

17. An antenna installation according to claim 15 providing power distribution to be adjustable between operators.

18. An antenna installation according to claim 1 arranged for antenna electrical pan and tilt to be adjustable.

19. An antenna installation according to claim 1 for which antenna electrical tilt and power distribution are adjustable.

20. A method of operation of a cellular radio antenna installation including splitting a base station signal into a plurality of split signals, and feeding the split signals to respective antennas, the antennas having beams which are sufficiently isolated from one another to provide for mutual interference to have negligible effect on communications performance.

21. A method according to claim 20 wherein the antennas are split signal antennas incorporated in an antenna assembly with other antennas of different gain.

22. A method according to claim 21 wherein not all of the antennas have the same beam width.

23. A method according to claim 21 wherein at least one of the other antennas has a beam which overlaps one or more sector or split signal antennas.

24. A method according to claim 20 including adjusting at least one of transmitted power and receiver sensitivity of an antenna relative to another antenna.

25. A method according to claim 20 including adjusting at least one of antenna electrical pan and tilt.

26. A method according to claim 20 including filtering to separate receive signals and routing them to different base station ports.

27. A method according to claim 20 wherein the antennas are arranged for transmit diversity.

28. A method according to claim 20 including amplifying split signals.

29. A method according to claim 20 including combining a plurality of base station transmit signals for antenna sharing purposes.

30. A method according to claim 29 implementing transmit polarisation diversity.

31. A method according to claim 29 wherein the combining filtering or hybrid coupling.

32. A method according to claim 20 including sharing the antennas between four operators.

33. A method according to claim 32 employing receive polarisation diversity.

34. A method according to claim 20 including sharing the antennas between a plurality of operators using contiguous signal frequencies, separating the signals into groups with non-contiguous frequencies, combining grouped signals and combining the groups.

35. A method according to claim 34 employing transmit diversity.

36. A method according to claim 34 including adjusting power distribution between operators.

37. A method according to claim 20 including adjusting antenna electrical pan and tilt.

38. A method according to claim 20 including adjusting antenna electrical tilt and power distribution.
